(19) United States
(12) Patent Application Publication
(10) Pub. No.: US 2026/0087726 A1
(43) Pub. Date: Mar. 26, 2026

(54) REAL-TIME INTERACTIVE THREE-DIMENSIONAL (3D) SCENE RECONSTRUCTION AND SIMULATION USING NEURAL REPRESENTATIONS

(71) Applicant: NVIDIA Corporation, Santa Clara, CA (US)

(72) Inventors: Or PEREL, Tel Aviv (IL); Clement Tse Tsian Christophe Louis FUJI TSANG, Toronto (CA); Chu Qing HU, Toronto (CA); Vismay MODI, Round Rock, TX (US); Karran PANDEY, Toronto (CA); Nicholas Mark Worth SHARP, Seattle, WA (US); Charles Teorell LOOP, Mercer Island, WA (US); David Isaac William LEVIN, Toronto (CA); Maria SHUGRINA, Toronto (CA)

(73) Assignee: NVIDIA Corporation, Santa Clara, CA (US)

(21) Appl. No.: 18/896,844

(22) Filed: Sep. 25, 2024

(51) Int. Cl. G06T 15/08; G06T 7/11

(52) U.S. Cl. CPC G06T 15/08; G06T 7/11; G06T 2207/10016; G06T 2207/10028

(57) ABSTRACT

Various examples, systems, and methods are disclosed relating to reconstructing, segmenting, and/or simulating pipeline. A first computing system can obtain video data including a depth map of a scene. The first computing system can reconstruct a three-dimensional (3D) representation of the scene using at least one or more Gaussian splat representations of one or more objects in the scene and the depth map. The first computing system can segment at least one object in the 3D representation. The first computing system can update at least one of the plurality of regions of the 3D representation within a threshold distance of the at least one object in the scene. The first computing system can generate at least one image of the 3D representation that depicts at least a portion of the at least one object for display.

### BACKGROUND

Three-dimensional (3D) scene reconstruction and interaction often involve the use of neural representations, such as neural radiance fields (NeRFs) or mesh-based methods, to create 3D environments from image and video data. These existing methods have limitations in terms of accuracy and efficiency, particularly when applied to interactive or real-time applications. For example, mesh-based representations can introduce inaccuracies due to discretization errors when approximating continuous surfaces. This poses challenges in accurately extracting surface data for simulating physical interactions. Neural reconstruction methods, such as neural radiance fields (NeRFs) or 3D Gaussian splats, inherently lack explicit surface definitions, unlike traditional mesh models. Consequently, generating meshes from these neural representations is computationally intensive and can result in geometric inaccuracies that affect simulation fidelity. Moreover, simulating deformations or managing object interactions using these neural representations often require algorithms to handle volumetric data accurately. These limitations reduce the realism and effectiveness of such simulations in augmented reality (AR) or virtual reality (VR) environments, where precise and real-time interaction models are critical. Additionally, while some methods can perform simulations on static meshes, neural representations such as NeRFs or 3D Gaussian splats can provide more detailed and realistic 3D reconstructions from multi-view images or videos. However, simulating these neural representations can be challenging because the neural representations often do not have an explicit surface like traditional meshes. At least one approach to address the challenge is to extract a mesh from these representations and then perform sampling within the mesh volume, but this conversion process can introduce errors and reduce fidelity.

### SUMMARY

Implementations of the present disclosure relate to systems and methods for 3D scene reconstruction, segmentation, and/or simulation using neural representations, combined with segmentation models and volumetric densification techniques. Systems and methods are disclosed that can use depth maps and video data to generate 3D representations that depict a scene. Segmentation models can be used to isolate objects within the 3D environment for manipulation and simulation. The implementations can further refine these 3D representations by performing operations such as inpainting or artifact removal to address inconsistencies or inaccuracies, improving the quality of the reconstructed scenes. For example, systems and methods in accordance with the present disclosure provide a pipeline for physical simulations by generating volumetric representations from 3D data, updating these volumes based at least in part on additional data inputs, and incorporating volumetric elements to perform realistic simulations of rigid and elastic objects.

Some implementations relate to a system including one or more processors to execute one or more operations including obtaining, from a video source, video data including a depth map of a scene. The one or more processors execute one or more operations to reconstruct, using at least one or more Gaussian splat representations and the depth map, the scene into a three-dimensional (3D) representation. The one or more processors execute one or more operations to segment at least one object in the 3D representation. The one or more processors execute one or more operations to generate a two-dimensional (2D) segmentation mask of a reference view of the video data. The one or more processors execute one or more operations to interpolate the 2D segmentation mask over a plurality of frames of the video data. The one or more processors execute one or more operations to map the 2D segmentation mask over the plurality of frames onto at least one corresponding region of a plurality of regions of the 3D representation in order to segment the at least one object in the 3D representation from the scene. The one or more processors execute one or more operations to update at least one of the plurality of regions of the 3D representation within a distance of the at least one object in the scene. The one or more processors execute one or more operations to display the at least one object.

In some implementations, the one or more processors are to execute one or more operations to densify the at least one object. In some implementations, densifying includes sampling a plurality of points on or approximately around the at least one object. In some implementations, densifying includes generating a voxelized volume of the at least one object based at least in part on the plurality of points. In some implementations, densifying includes updating the voxelized volume based at least in part on an occupancy state of at least one voxel of a plurality of voxels of the voxelized volume based at least in part on at least one rendered depth map.

In some implementations, the one or more processors are to execute one or more operations to populate an interior of the voxelized volume based at least in part on injecting a plurality of volumetric elements in the interior of the at least one object including a plurality of interior regions. In some implementations, the one or more processors execute one or more operations to simulate one or more interactions of the voxelized volume of the at least one densified object to update at least one physical attribute of the at least one object, the at least one densified object corresponding to a volumetric representation.

In some implementations, simulating the one or more interactions includes performing a rigidity simulation, which includes applying, using a first physics model, a first plurality of transformations to the at least one densified object to obtain a plurality of rigid motions of the at least one densified object. In some implementations, applying includes determining an energy function using at least one of a plurality of scene parameters or a plurality of object parameters. In some implementations, applying includes minimizing the energy function to determine a plurality of rigid states of the at least one densified object. In some implementations, applying includes applying the plurality of rigid states to simulate the plurality of rigid motions of the at least one densified object over time.

In some implementations, simulating the one or more interactions includes performing an elasticity simulation including applying, using a second physics model, a second plurality of transformations to the at least one densified object to obtain a plurality of deformed states of the at least one densified object. In some implementations, applying includes determining an energy function using at least one of a plurality of scene parameters or a plurality of object parameters. In some implementations, applying includes minimizing the energy function to determine a plurality of updates to a plurality of control points. In some implementations, applying includes calculating one or more deformations of the at least one densified object based at least in part on the plurality of updates to the plurality of control points and a plurality of corresponding skinning fields.

In some implementations, the reconstruction is further based at least one of (i) at least one refined pose of the video source and a plurality of two-dimensional (2D) frames of the video data. In some implementations, the reconstruction further includes updating at least one initial pose of the video source to the at least one refined pose based at least in part on aligning the 3D representation with the plurality of 2D frames of the video data.

In some implementations, the one or more processors are to execute the one or more operations including generate an initial Gaussian based at least in part on depth data of the depth map and the at least one initial pose of the video source. In some implementations, the one or more processors are to execute the one or more operations including generate a 3D reconstruction based at least in part on the initial Gaussian, the at least one refined pose of the video source, and the plurality of 2D frames.

In some implementations, segmenting including using a segmentation model. In some implementations, the reference view is based at least in part on a user input selecting the at least one object. In some implementations, the reference view corresponding to a frame of the plurality of frames of the video data.

In some implementations, updating the at least one of the plurality of regions of the 3D representation within the distance is based at least in part on filling at least one of the plurality of regions within the distance based at least in part on sampling data of one or more adjacent regions. In some implementations, updating the at least one of the plurality of regions of the 3D representation within the distance is based at least in part on removing one or more elements of at least one of the plurality of regions within the distance. In some implementations, updating the at least one of the plurality of regions of the 3D representation within the distance is based at least in part on updating the at least one of the plurality of regions based at least in part on sampling data of one or more regions of the plurality of regions of the 3D representation.

Some implementations relate to one or more processors including one or more circuits which are to receive video data including a depth map of a scene. The one or more circuits are to reconstruct, using at least one or more Gaussian splat representations and the depth map, the scene into a three-dimensional (3D) representation. The one or more circuits are to segment at least one object in the 3D representation based at least in part on mapping a two-dimensional (2D) segmentation mask of a reference view of the video data over a plurality of frames onto at least one corresponding region of a plurality of regions of the 3D representation. The one or more circuits are to update at least one of the plurality of regions of the 3D representation within a distance of the at least one object in the scene. The one or more circuits are to generate at least one image that depicts at least a portion of the at least one object for display.

In some implementations, the one or more circuits are to densify the at least one object. In some implementations, the one or more circuits are to sample a plurality of points on or approximately around the at least one object. In some implementations, the one or more circuits are to generate a voxelized volume of the at least one object based at least in part on the plurality of points. In some implementations, the one or more circuits are to update the voxelized volume based at least in part on an occupancy state of at least one voxel of a plurality of voxels of the voxelized volume based at least in part on at least one rendered depth map.

In some implementations, the one or more circuits are to populate an interior of the voxelized volume based at least in part on injecting a plurality of volumetric elements in the interior of the at least one object including a plurality of interior regions. In some implementations, the one or more circuits are to simulate one or more interactions of the voxelized volume of the at least one densified object to update at least one physical attribute of the at least one object. In some implementations, the at least one densified object corresponds to a volumetric representation.

In some implementations, simulating the one or more interactions includes performing a rigidity simulation including applying, using a first physics model, a first plurality of transformations to the at least one densified object to obtain a plurality of rigid motions of the at least one densified object. In some implementations, applying includes determining an energy function using at least one of a plurality of scene parameters or a plurality of object parameters. In some implementations, applying includes minimizing the energy function to determine a plurality of rigid states of the at least one densified object. In some implementations, applying includes applying the plurality of rigid states to simulate the plurality of rigid motions of the at least one densified object over time.

In some implementations, simulating the one or more interactions includes performing an elasticity simulation including applying, using a second physics model, a second plurality of transformations to the at least one densified object to obtain a plurality of deformed states of the at least one densified object. In some implementations, applying includes determining an energy function using at least one of a plurality of scene parameters or a plurality of object parameters. In some implementations, applying includes minimizing the energy function to determine a plurality of updates to a plurality of control points. In some implementations, applying includes calculating one or more deformations of the at least one densified object based at least in part on the plurality of updates to the plurality of control points and a plurality of corresponding skinning fields.

In some implementations, the reconstruction is further based on at least one of: (i) at least one refined pose of the video source, or (ii) a plurality of two-dimensional (2D) frames of the video data. In some implementations, the reconstruction further includes updating at least one initial pose of the video source to the at least one refined pose based at least in part on aligning the 3D representation with the plurality of 2D frames of the video data.

Some implementation relates to a method. The method includes receiving, by one or more processors, video data including a depth map of a scene. The method includes reconstructing, by the one or more processors using at least Gaussian splatting and the depth map, the scene into a three-dimensional (3D) representation. The method includes segmenting, by the one or more processors, at least one object in the 3D representation. The method includes updating, by the one or more processors, at least one of a plurality of regions of the 3D representation within a distance of the at least one object in the scene. The method includes densifying, by the one or more processors, the at least one object by generating a voxelized volume of the at least one object and updating the voxelized volume based at least in part on an occupancy state of at least one voxel of a plurality of voxels of the voxelized volume based at least in part on at least one rendered depth map. The method includes simulating, by the one or more processors, one or more interactions of the voxelized volume of the at least one densified object. The method includes displaying, by the one or more processors and using a display device, at least one rendered image depicting at least a portion of the at least one object.

In some implementations, the method further includes populating, by the one or more processors, an interior of the voxelized volume based at least in part on injecting a plurality of volumetric elements in the interior of the at least one object including a plurality of interior regions. In some implementations, simulating the one or more interactions includes performing a rigidity simulation. In some implementations, the rigidity simulation includes applying, by the one or more processors using a first physics model, a first plurality of transformations to the at least one densified object to obtain a plurality of rigid motions of the at least one densified object. In some implementations, applying includes determining an energy function using at least one of a plurality of scene parameters or a plurality of object parameters. In some implementations, applying includes minimizing the energy function to determine a plurality of rigid states of the at least one densified object. In some implementations, applying includes applying the plurality of rigid states to simulate the plurality of rigid motions of the at least one densified object over time.

In some implementations, simulating the one or more interactions includes performing an elasticity simulation. In some implementations, the elasticity simulation includes applying, by the one or more processors using a second physics model, a second plurality of transformations to the at least one densified object to obtain a plurality of deformed states of the at least one densified object. In some implementations, applying includes determining an energy function using at least one of a plurality of scene parameters or a plurality of object parameters. In some implementations, applying includes minimizing the energy function to determine a plurality of updates to a plurality of control points. In some implementations, applying includes calculating one or more deformations of the at least one densified object based at least in part on the plurality of updates to the plurality of control points and a plurality of corresponding skinning fields.

Some implementations relate to a system including one or more processors to a system. The one or more operations include at least one operation to receive and/or obtain at least one object segmented from video data. The one or more operations include at least one operation to densify the at least one object. In some implementations, densifying includes sampling a plurality of points on or approximately around the at least one object. In some implementations, densifying includes generating a voxelized volume of the at least one object based at least in part on the plurality of points. In some implementations, densifying includes updating the voxelized volume based at least in part on an occupancy state of at least one voxel of a plurality of voxels of the voxelized volume based at least in part on at least one rendered depth map. The one or more operations include at least one operation to simulate one or more interactions of the voxelized volume of the at least one densified object to update at least one physical attribute of the at least one object. The one or more operations include at least one operation to generate an image that depicts at least a portion of the at least one object for display using a display device.

In some implementations, the one or more operations include at least one operation to populate an interior of the voxelized volume based at least in part on injecting a plurality of volumetric elements in the interior of the at least one object including a plurality of interior regions. In some implementations, the at least one densified object corresponds to a volumetric representation.

In some implementations, simulating the one or more interactions includes performing a rigidity simulation including applying, using a first physics model, a first plurality of transformations to the at least one densified object to obtain a plurality of rigid motions of the at least one densified object. In some implementations, obtaining the plurality of rigid motions of the at least one densified object includes determining an energy function using at least one of a plurality of scene parameters or a plurality of object parameters. In some implementations, obtaining the plurality of rigid motions of the at least one densified object includes minimizing the energy function to determine a plurality of rigid states of the at least one densified object. In some implementations, obtaining the plurality of rigid motions of the at least one densified object includes applying the plurality of rigid states to simulate the plurality of rigid motions of the at least one densified object over time.

In some implementations, simulating the one or more interactions includes performing an elasticity simulation including applying, using a second physics model, a second plurality of transformation to the at least one densified object to obtain a plurality of deformed states of the at least one densified object. In some implementations, obtaining the plurality of deformed states of the at least one densified object includes determining an energy function using at least one of a plurality of scene parameters or a plurality of object parameters. In some implementations, obtaining the plurality of deformed states of the at least one densified object includes minimizing the energy function to determine a plurality of updates to a plurality of control points. In some implementations, obtaining the plurality of deformed states of the at least one densified object includes calculating one or more deformations of the at least one densified object based at least in part on the plurality of updates to the plurality of control points and a plurality of corresponding skinning fields.

Some implementations relate to one or more processors including one or more circuits to receive and/or obtain at least one object segmented from video data. The one or more circuits are to densify the at least one object. In some implementations, densifying includes sampling a plurality of points on or approximately around the at least one object. In some implementations, densifying includes generating a voxelized volume of the at least one object based at least in part on the plurality of points. In some implementations, densifying includes updating the voxelized volume based at least in part on an occupancy state of at least one voxel of a plurality of voxels of the voxelized volume based at least in part on at least one rendered depth map. The one or more circuits are to simulate one or more interactions of the voxelized volume of the at least one densified object to update at least one physical attribute of the at least one object. The one or more circuits are to generate a at least one image of the at least one object using the at least one updated physical attribute.

In some implementations, the one or more circuits are to populate an interior of the voxelized volume based at least in part on injecting a plurality of volumetric elements in the interior of the at least one object including a plurality of interior regions. In some implementations, the at least one densified object corresponds to a volumetric representation.

In some implementations, simulating the one or more interactions includes performing a rigidity simulation including applying, using a first physics model, a first plurality of transformations to the at least one densified object to obtain a plurality of rigid motions of the at least one densified object. In some implementations, obtaining the plurality of rigid motions of the at least one densified object includes determining an energy function using at least one of a plurality of scene parameters or a plurality of object parameters. In some implementations, obtaining the plurality of rigid motions of the at least one densified object includes minimizing the energy function to determine a plurality of rigid states of the at least one densified object. In some implementations, obtaining the plurality of rigid motions of the at least one densified object includes applying the plurality of rigid states to simulate the plurality of rigid motions of the at least one densified object over time.

In some implementations, simulating the one or more interactions includes performing an elasticity simulation including applying, using a second physics model, a second plurality of transformation to the at least one densified object to obtain a plurality of deformed states of the at least one densified object. In some implementations, obtaining the plurality of deformed states of the at least one densified object includes determining an energy function using at least one of a plurality of scene parameters or a plurality of object parameters. In some implementations, obtaining the plurality of deformed states of the at least one densified object includes minimizing the energy function to determine a plurality of updates to a plurality of control points. In some implementations, obtaining the plurality of deformed states of the at least one densified object includes calculating one or more deformations of the at least one densified object based at least in part on the plurality of updates to the plurality of control points and a plurality of corresponding skinning fields.

Some implementations relate to a method. The method including receiving, by one or more processors, at least one object segmented from video data. The method including densifying, by the one or more processors, the at least one object. In some implementations, densifying includes sampling a plurality of points on or approximately around the at least one object. In some implementations, densifying includes generating a voxelized volume of the at least one object based at least in part on the plurality of points. In some implementations, densifying includes updating the voxelized volume based at least in part on an occupancy state of at least one voxel of a plurality of voxels of the voxelized volume based at least in part on at least one rendered depth map. The method including simulating, by the one or more processors, one or more interactions of the voxelized volume of the at least one densified object to update at least one physical attribute of the at least one object. The method including displaying, by the one or more processors and using a display device, at least one rendered image depicting at least a portion of the at least one object.

In some implementations, the method further includes populating, by the one or more processors, an interior of the voxelized volume based at least in part on injecting a plurality of volumetric elements in the interior of the at least one object including a plurality of interior regions. In some implementations, the at least one densified object corresponds to a volumetric representation.

In some implementations, simulating the one or more interactions includes performing a rigidity simulation includes applying, by the one or more processors using a first physics model, a first plurality of transformations to the at least one densified object to obtain a plurality of rigid motions of the at least one densified object. In some implementations, simulating the one or more interactions includes performing an elasticity simulation including applying, by the one or more processors using a second physics model, a second plurality of transformation to the at least one densified object to obtain a plurality of deformed states of the at least one densified object.

The processors, systems, and/or methods described herein can be implemented by or included in at least one a system. The system can include a system for performing gaming. The system can include a system for performing content streaming. The system can include a system for performing collaborative content creation. The system can include a system for performing simulation operations. The system can include a system for performing collaborative content creation for 3D assets. The system can include a system for generating synthetic data. The system can include a system including one or more vision language models (VLMs). The system can include a system including one or more large language models (LLMs). The system can include a system for performing conversational AI operations. The system can include a system for performing light transport simulation. The system can include a system for performing deep learning operations. The system can include a system for performing digital twin operations. The system can include a control system for an autonomous or semi-autonomous machine. The system can include a perception system for an autonomous or semi-autonomous machine. The system can include a system incorporating one or more virtual machines (VMs). The system can include a system implemented using a robot. The system can include a system implemented using an edge device. The system can include a system implemented at least partially in a data center. The system can include a system implemented at least partially using cloud computing resources. The system can include a system for generating interactive 3D visualizations. The system can include a system implemented at least partially using augmented reality (AR) or virtual reality (VR) platforms.

### BRIEF DESCRIPTION OF THE DRAWINGS

The present systems and methods for reconstructing and interacting with 3D environments are described in detail below with reference to the attached drawing figures, wherein:

FIG. 1 is a block diagram of an example of a system, in accordance with some implementations of the present disclosure;

FIG. 2 is a block diagram of an example reconstruction stage in an example pipeline, in accordance with some implementations of the present disclosure;

FIG. 3A is a block diagram of an example segmentation stage in an example pipeline, in accordance with some implementations of the present disclosure;

FIG. 3B is a block diagram of another example segmentation stage in an example pipeline, in accordance with some implementations of the present disclosure;

FIG. 4 is a block diagram of an example preprocessing stage in an example pipeline, in accordance with some implementations of the present disclosure;

FIG. 5 is a block diagram of an example densification stage in an example pipeline, in accordance with some implementations of the present disclosure;

FIG. 6A is a block diagram of an example simulation stage in an example pipeline, in accordance with some implementations of the present disclosure;

FIG. 6B is a block diagram of an example rigid simulation stage in an example pipeline, in accordance with some implementations of the present disclosure;

FIG. 6C is a block diagram of an example elasticity simulation stage in an example pipeline, in accordance with some implementations of the present disclosure;

FIG. 7 is a block diagram of an example simulation of an object in an example pipeline, in accordance with some implementations of the present disclosure;

FIG. 8A is a flow diagram of an example of a method for scene reconstruction, segmentation, preprocessing, densification, and/or simulation in an example pipeline, in accordance with some implementations of the present disclosure;

FIG. 8B is a flow diagram of an example of a method for object densification and/or simulation in an example pipeline, in accordance with some implementations of the present disclosure;

FIG. 9A is a block diagram of an example generative language model system for use in implementing at least some implementations of the present disclosure;

FIG. 9B is a block diagram of an example generative language model that includes a transformer encoder-decoder for use in implementing at least some implementations of the present disclosure;

FIG. 9C is a block diagram of an example generative language model that includes a decoder-only transformer architecture for use in implementing at least some implementations of the present disclosure;

FIG. 10 is a block diagram of an example computing device for use in implementing at least some implementations of the present disclosure; and

FIG. 11 is a block diagram of an example data center for use in implementing at least some implementations of the present disclosure.

### DETAILED DESCRIPTION

This disclosure relates to systems and methods for reconstructing, segmenting, and/or interacting with three-dimensional (3D) environments using volumetric representations, such as Gaussian splats, utilizing improved implementations that segment, densify, and simulate objects within a scene. For example, systems and methods in accordance with the present disclosure involve the generation of 3D representations from video data and depth information, which can be used for object manipulation, simulation, and visualization in augmented reality (AR) and virtual reality (VR) platforms. That is, existing systems often fail to provide accurate real-time interaction and simulation capabilities due to limitations in object segmentation, volumetric representation, and physical simulations. Instead, the implementations described herein can use 3D representations, segmentation models, and volumetric densification to create more accurate and efficient real-time 3D reconstructions, supporting object manipulation, realistic physical simulations, and interactive experiences in AR and VR.

Additionally, generating mesh-based representations from neural data such as NeRFs or 3D Gaussians can be computationally intensive and result in geometric inaccuracies, as these neural representations inherently can lack an explicit surface definition. That is, while traditional mesh-based approaches can suffer from discretization errors, an issue with neural-based reconstruction is obtaining a usable mesh representation. For example, one approach can include extracting a mesh from neural representations and using this mesh for simulations, which often uses multipart conversion processes and can reduce the fidelity of the resulting model. In another example, neural representations can be simulated directly, avoiding the surface extraction but using methods to simulate volumetric interactions within the data. Thus, the systems and methods address these challenges by simulating neural representations, managing the complexities of volumetric densification and interaction modeling, thereby improving the accuracy and efficiency of real-time 3D simulations in augmented reality (AR) and virtual reality (VR) environments.

Implementations of the present disclosure provide systems and methods for simulating three-dimensional (3D) environments using neural representations, such as NeRFs and 3D Gaussian splats, which can generate high-quality 3D reconstructions from multi-view images or videos. Unlike traditional mesh-based approaches, the neural representations can represent challenges for simulation as they often lack clearly defined surfaces. The disclosed systems and methods employ sampling within the volumetric data of these representations to facilitate accurate simulations of physical interactions, without relying on conversion to mesh form. This technological solution reduces potential errors associated with traditional mesh extraction methods and supports efficient, realistic simulations for various applications in dynamic environments.

Some techniques for 3D scene reconstruction, segmentation, and/or interaction rely on neural radiance fields (NeRFs) or mesh representations, which often result in inaccurate or inefficient representations for object segmentation, interaction, and physical simulation. These techniques often do not provide high-quality interactive 3D reconstructions, as they are unable to adjust to real-time object manipulation or accurately manage physical forces and deformations. The limitations include ineffective segmentation, inaccurate transformations, and inadequate volumetric representations. For example, mesh-based methods can result in inaccuracies in representing object deformation and interaction under physical forces, which results in reduced realism and usability. Additionally, segmentation and densification approaches can prevent processing within real-time constraints for AR and VR applications, resulting in inefficiencies in rendering and interaction.

Systems and methods in accordance with the present disclosure can improve accuracy and efficiency in 3D scene reconstruction, segmentation, and/or simulation by providing a framework using neural representations and volumetric densification. For example, a plurality of neural representations (e.g., Gaussian splats, referred to collectively herein as a “3D representation”) can be generated to represent the 3D environment based at least in part on depth maps (e.g., low-resolution depth maps captured from LiDAR sensors) and video data (e.g., RGB frames with camera intrinsics and poses). Additionally, one or more segmentation models (e.g., Segment Anything Model, SAM) can be used to isolate objects for manipulation and simulation. In some implementations, parameters such as depth maps, camera poses, and/or 2D segmentation masks (e.g., binary masks generated for different object views) can be used to represent the features of the 3D content with relevance and importance. The implementations can further refine the 3D representation by updating regions of the neural representations within a given distance threshold (e.g., proximity-based selection) to remediate inconsistencies or inaccuracies, such as artifacts or missing data. For example, refining the 3D representation can include performing inpainting (e.g., filling gaps or holes using data from adjacent regions) and artifact removal (e.g., discarding or replacing poorly reconstructed areas).

In some implementations, a densification process can be performed by generating a voxelized volume from sampled points (e.g., converting neural representations to a voxel grid) and updating it based at least in part on rendered depth maps (e.g., depth carving to remove unoccupied regions) to provide an accurate volumetric mass for simulations. Generally, the densification process can include voxelizing 3D Gaussians to create a voxelized shell (e.g., where only the voxels approximating the surface of the shape are occupied). Additionally, depth maps can be used to carve out unoccupied regions around this voxelized shell, resulting in a dense volume that represents the interior of the shape. The dense volume can then be used to sample isotropic 3D Gaussians, which can be utilized for simulating physical interactions within the object. Once densified, the implementations can populate the interior of the voxelized volume with additional volumetric elements (e.g., injecting isotropic Gaussians), to facilitate realistic physical simulations, such as rigid body (e.g., simulating solid objects) and elasticity simulations (e.g., modeling deformation under forces), to predict object behaviors under different forces. The improvements provide improved accuracy and interactive framework for 3D scene reconstruction, enhancing the realism and usability of AR and VR environments and other applications by reducing computational inefficiencies and improving the quality of object representations and simulations.

In some implementations, video data captured from a device can include RGB frames and camera information (e.g., intrinsics and poses). For example, a low-resolution depth map can be converted into a point cloud, which can be used to generate neural representations (e.g., Gaussian splats, collectively forming or creating a 3D representation) that can reconstruct the 3D scene. A segmentation model can be used to generate 2D segmentation masks that can be interpolated across multiple frames, and video tracking can be used to propagate the masks over time. That is, the segmentation process can be used to map 2D masks to corresponding 3D neural representations, facilitating object segmentation within the 3D space. In some implementations, the attributes of the 3D representation can be refined using densification. For example, points can be sampled on object surfaces to generate a voxelized volume. The voxelized volume (e.g., voxelized shell) can be updated based at least in part on rendered depth maps. Additionally, volumetric elements (e.g., isotropic Gaussians) can be injected into the interior of objects to facilitate realistic physical simulations based at least in part on using depth maps to carve the space around the voxelized shell (e.g., with the dense volume remaining).

The systems and methods described herein can be used for a variety of purposes, including but not limited to, 3D environment reconstruction, object manipulation in AR/VR, simulation-based training applications, digital twin creation, and interactive content development. These methods can improve efficiency in tasks involving 3D visualization, such as gaming, robotics, and automated driving simulations.

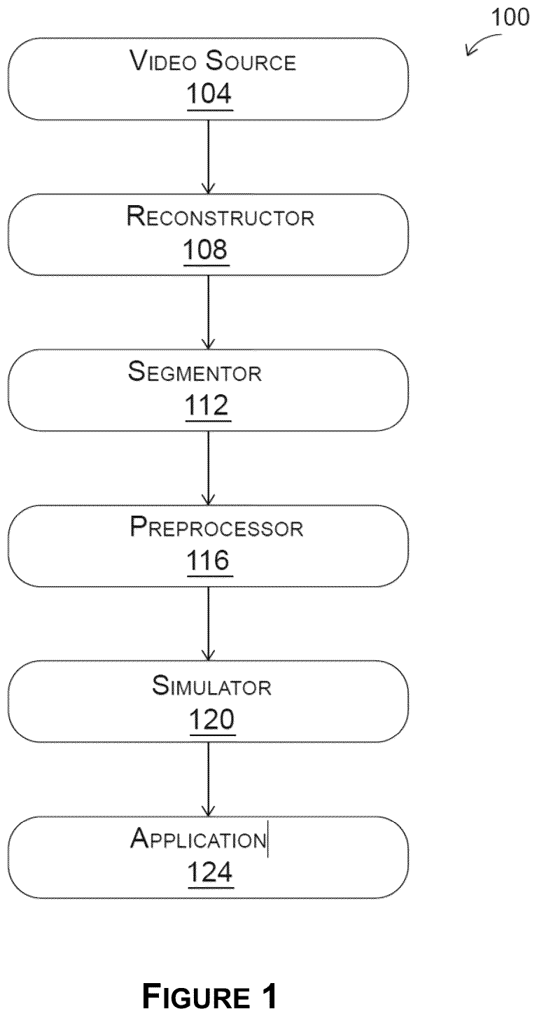

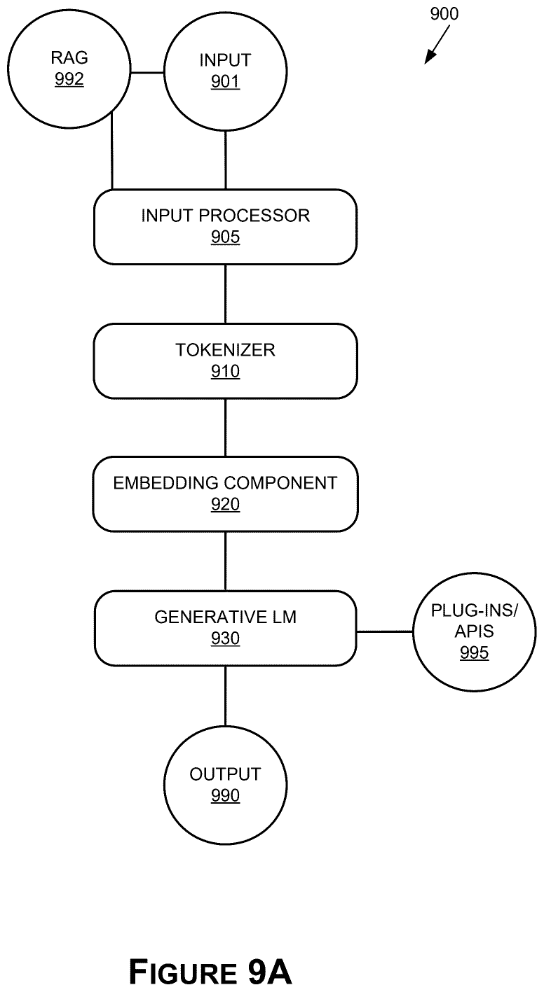

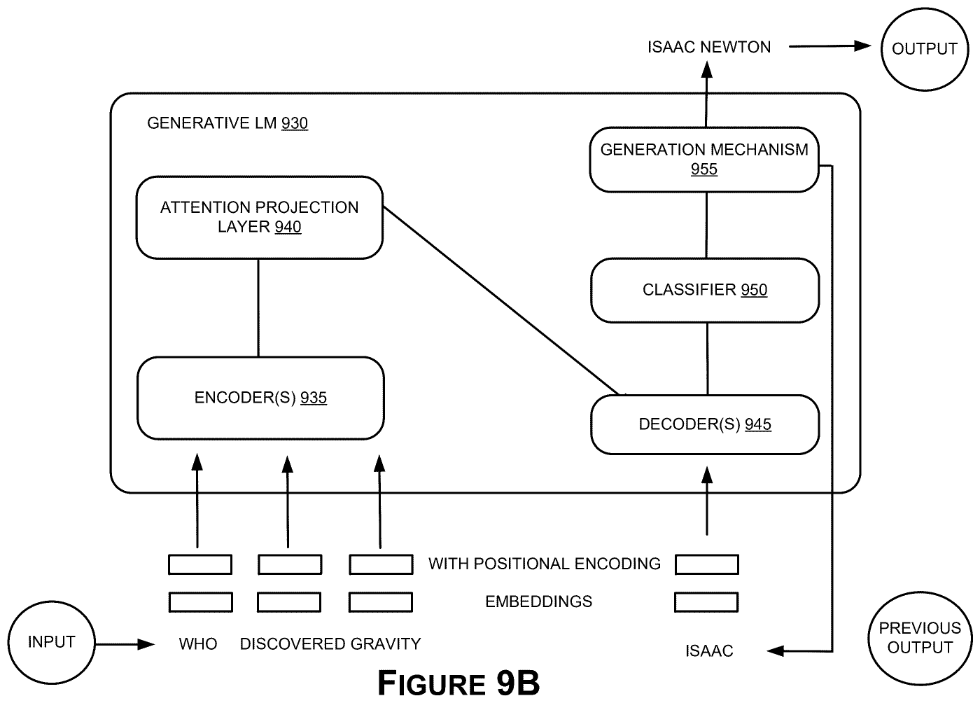

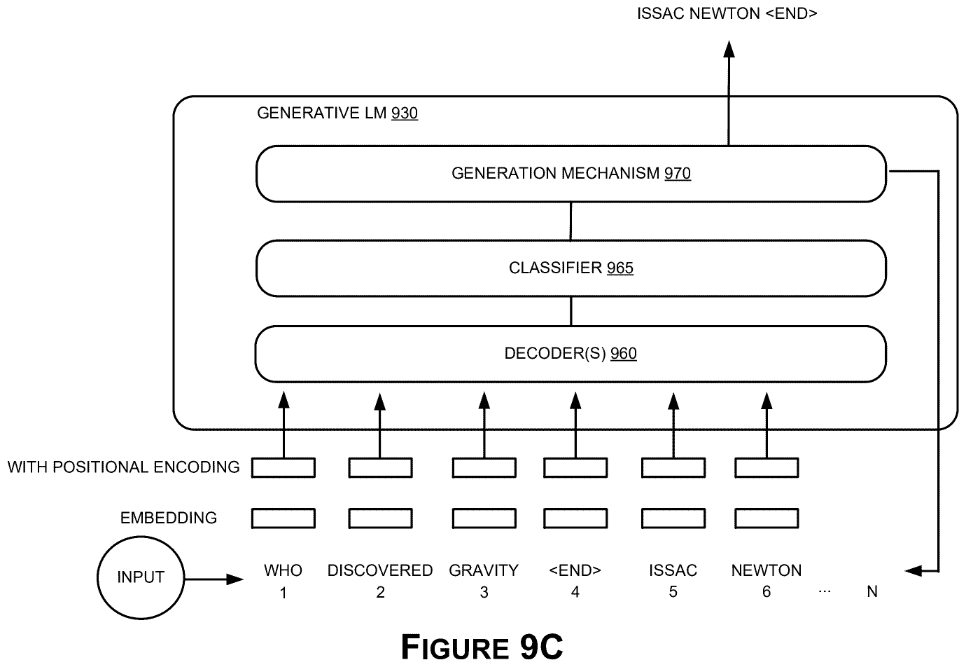

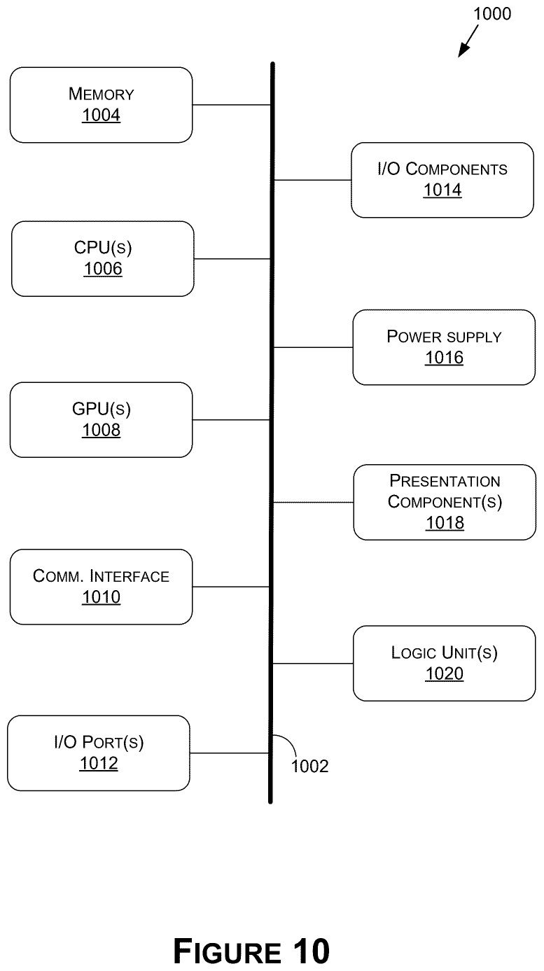

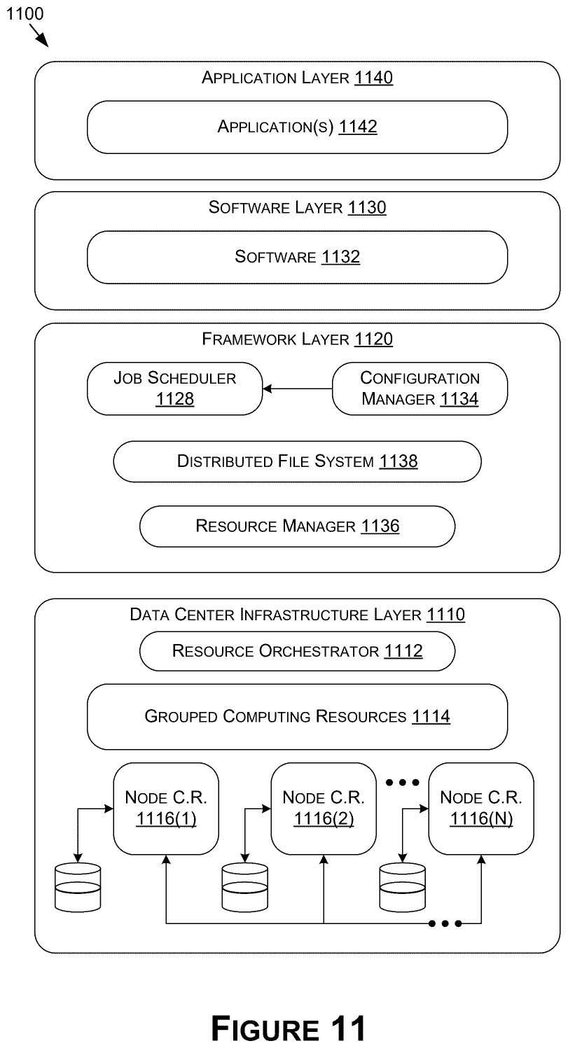

With reference to FIG. 1, FIG. 1 is an example block diagram of a system 100, in accordance with some implementations of the present disclosure. It should be understood that this and other arrangements described herein are set forth only as examples. Other arrangements and elements (e.g., machines, interfaces, functions, orders, groupings of functions, etc.) can be used in addition to or instead of those shown, and some elements can be omitted altogether. Further, many of the elements described herein are functional entities that can be implemented as discrete or distributed components or in conjunction with other components, and in any combination and location. Various functions described herein as being performed by entities can be carried out by hardware, firmware, and/or software. For example, various functions can be carried out by a processor executing instructions stored in memory. In some implementations, the systems, methods, and processes described herein can be executed using similar components, features, and/or functionality to those of example generative language model system 900 of FIG. 9A, example generative LM 930 of FIGS. 9B-9C, example computing device 1000 of FIG. 10, and/or example data center 1100 of FIG. 11.

The system 100 can implement at least a portion of a 3D reconstruction, segmentation, and/or simulation (RCS) pipeline. For example, the system 100 can process video data and depth maps to generate three-dimensional (3D) representations for object segmentation, manipulation, and physical simulation. The system 100 can be used to perform real-time 3D reconstruction, object interaction, and simulation by any of various systems described herein, including but not limited to AR and VR systems, autonomous driving systems, robotics systems, gaming systems, and/or digital twin systems.

Generally, the 3D RCS pipeline can include operations performed by the system 100. For example, the 3D RCS pipeline can include any one or more of a video reception stage, a reconstruction stage, a segmentation stage, a preprocessing stage, a simulation stage, and/or a display stage.

The system 100 (e.g., implementing the 3D RCS pipeline) can receive and/or obtain video data and depth information to reconstruct three-dimensional (3D) environments using neural representations and volumetric densification. Additionally, the system 100 can process and segment objects in 3D space using generated 2D segmentation masks that can be interpolated over multiple frames. In some implementations, the system 100 can perform inpainting and artifact removal (e.g., prior to simulation) to refine specific regions of the 3D representation (e.g., within a distance of the segmented object). Thus, the 3D RCS pipeline can improve the quality of 3D environment reconstructions and facilitate accurate physical simulations, reducing inconsistencies in object representation and enhancing the fidelity of object interactions.

In some implementations, the video reception stage can be the stage in the 3D RCS pipeline in which the system 100 prepares captured video data (e.g., RGB frames with camera intrinsics and poses) and depth information for initial processing and/or alignment evaluation. For example, the video source 104 can provide data in formats such as raw RGB and/or depth maps, which the reconstructor 108 can process to extract pixel-level information for reconstructing the 3D environment. In some implementations, the video reception stage can perform operations that prepare depth maps by correcting for any discrepancies in the camera poses that can affect the segmentation and/or simulation processes.

The system 100 can include or be coupled with at least one data source 104. The data source 104 can include data such as video data, sensor data, and/or image data. The data source 104 can include data from (or be implemented by) one or more sensors, such as any one or more cameras (e.g., RGB-D cameras), LiDAR sensors, and/or depth sensors. For example, the data source 104 can include data structured as image frames and/or video frames, which can include a plurality of pixels to represent information captured by the respective sensor(s) that outputted the data. The data source 104 can include two-dimensional and/or three-dimensional image data and/or video data.

In some implementations, the data source 104 includes training data (e.g., for training a segmentation model(s) and/or simulation model(s)). For example, the data source 104 can include one or more example frames, each of the example frames assigned a label. The label can indicate at least one identifier of an object represented in the example frame, such as a region of interest, segmentation mask, or classification (e.g., type, category). The label can include object data such as a 3D region, volumetric density, or metadata. In some implementations, the segmentation model and/or simulation model can be configured based at least in part on at least some data other than data of the data source 104. The system 100 can retrieve data from the data source 104 as one or more streams of data. For example, the data can be retrieved according to a streaming protocol. The data from the data source 104 can be encoded, such as to be encoded according to one or more encoding parameters.

In some implementations, the system 100 includes at least one reconstructor 108. At the reconstruction stage, the reconstructor 108 can apply any of various reconstruction operations to the data from the data source 104, such as to perform reconstruction based at least in part on Gaussian splatting (e.g., one or more Gaussian splat representations) and the depth map. The reconstructor 108 can generate an initial set of one or more neural representations (e.g., Gaussian splats as 3D distributions) based at least in part on depth data of the depth map and the at least one initial pose of the video source. The reconstructor 108 can further refine the 3D representation(s) by aligning the initial neural representations with the two-dimensional (2D) video frames using updated camera poses. The refined 3D representation(s) can be provided to or used in subsequent stages for further processing.

In the reconstruction stage, the reconstructor 108 can generate a 3D representation (e.g., one or more neural representations) of a scene using video data and associated depth information. For example, the reconstructor 108 can convert low-resolution depth maps (e.g., 192×256 resolution) obtained from depth sensors (e.g., LiDAR sensors on mobile phones, tablets, and/or other smart devices) into at least one point cloud (e.g., representing the scene as a collection of 3D points). The reconstructor 108 can use the point cloud to generate volumetric neural representations (e.g., Gaussian splats, voxel grids, multi-resolution grids). For example, Gaussians splats can be a 3D Gaussian distribution that models the spatial properties of the scene. That is, the reconstructor 108 can align the splats with 2D frames by refining the parameters (e.g., mean, covariance, orientation, and/or other shape information) based at least in part on feedback from camera intrinsics and extrinsics.

In some implementations, the reconstructor 108 can obtain (e.g., virtual) camera parameters such as intrinsics (e.g., focal length, optical center) and extrinsics (e.g., position, orientation) using auxiliary data sources, such as ARKit via NVIDIA iOS applications. For example, the reconstructor 108 can receive the parameters as initial estimates, which can be inaccurate, and perform optimization to refine them. For example, the reconstructor 108 can adjust the 3D point positions and camera parameters iteratively to reduce the discrepancies between the projected 3D points and the observed 2D image points. The reconstructor 108 can use bundle adjustment to iteratively update the camera poses and 3D points to minimize reprojection errors between the observed 2D video frames and the projected 3D splats. In another example, the reconstructor 108 can apply non-linear least squares optimization to adjust both the Gaussian splats and camera parameters simultaneously, ensuring a more accurate alignment with the video frames.

Additionally, the reconstructor 108 can perform reconstruction onto different types of 3D representations based at least in part on the specific use case. For example, the reconstructor 108 can generate Neural Radiance Fields (NeRFs) if the application includes detailed volumetric renderings of the scene. In another example, the reconstructor 108 can generate a mesh representation by converting the point cloud into a polygonal surface model. In some implementations, the reconstructor 108 can determine which representation to use based at least in part on various features such as computational resources, desired fidelity, and the specific requirements of downstream processes (e.g., rendering, object manipulation).

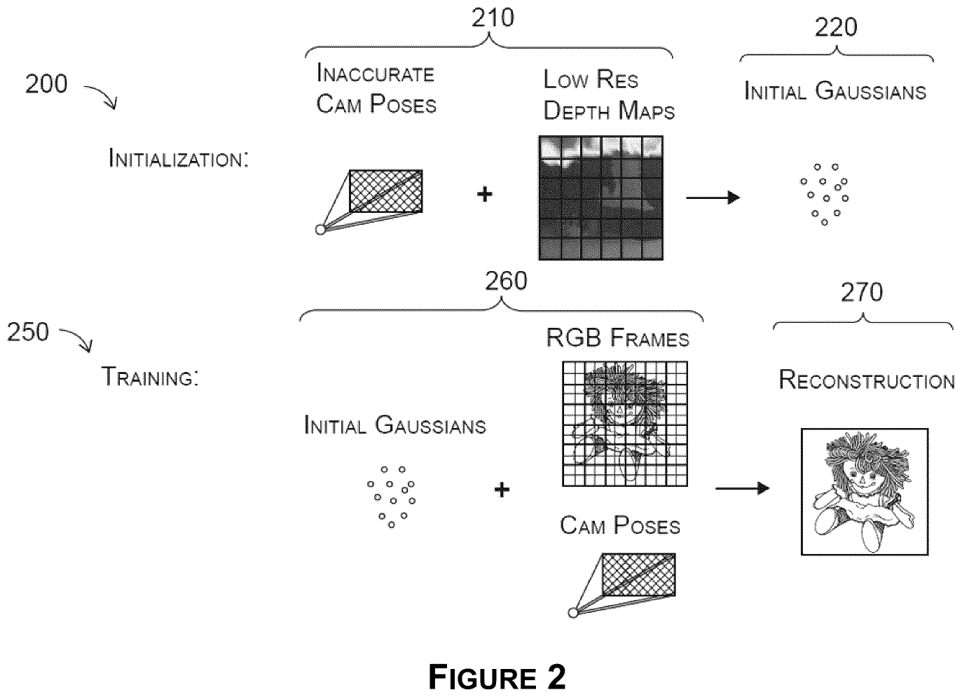

In some implementations, the reconstructor 108 can partially optimize (also referred to herein as “reconstruct”) a scene and provide the intermediate output to subsequent stages in the pipeline. That is, the segmentor 112, in the segmentation stage, can begin processing the partially optimized scene while additional optimizations (or reconstructions) are still occurring in the background. For example, the segmentor 112 can start identifying and categorizing objects in the scene based at least in part on the initial reconstruction data. Additionally, the simulation stage can be run asynchronously, using the segmented data to simulate interactions and behaviors within the scene, while the visual quality continues to improve as optimizations are applied to the reconstruction output. Reconstruction is described in greater detail below with reference to FIG. 2.

In some implementations, the segmentation stage can refer to the stage in the 3D RCS pipeline in which the system 100 isolates objects from the 3D representation. That is, the segmentor 112 can generate a two-dimensional (2D) segmentation mask (e.g., binary mask identifying specific regions corresponding to the object) of a reference view of the video data. For example, the reference view can be based at least in part on a user selecting an object of interest in a specific frame of a video. In this example, the reference view can correspond to a frame (e.g., snapshot of the video) for object segmentation. The segmentation stage can interpolate the 2D segmentation mask over a plurality of frames of the video data (e.g., maintaining consistency across frames). The segmentation stage can map the 2D segmentation mask over the plurality of frames onto at least one corresponding region of the 3D representation to segment the at least one object in the 3D representation from the scene.

In some implementations, the segmentation stage can include a semi-interactive process where the segmentor 112 can generate 2D segmentation masks of objects within the video data. That is, the segmentor 112 can allow the user to select a reference view, corresponding to a frame of the video data, and provide one or more selections (e.g., mouse clicks, taps, etc.) to guide the segmentation model (e.g., an image segmentation model that can generate pixel-wise masks from input images, a model that can use user-provided points to delineate objects, and/or any region-based model that can refine boundaries based at least in part on iterative user input) to identify the foreground object. For example, the user can click on different parts of an object (e.g., rag doll) on a surface (e.g., table) to guide the algorithm in determining which regions represent the object. In this example, the segmentation model can create a 2D mask that delineates the object from the surrounding objects or background in the reference view.

In the segmentation stage, the segmentor 112 can perform additional operations by allowing the user to change the view and provide more selections to refine the segmentation mask. For example, the user can rotate the camera to view the back of the object, providing additional selections that can help the segmentation model adjust the segmentation mask based at least in part on this new perspective. In another example, the user can select different features that distinguish the back of the object (e.g., rag doll) from the rest of the scene, allowing the segmentor 112 to capture details that are not visible from the front view. The segmentor 112 can use these multiple views to refine the segmentation mask further.

At the segmentation stage, the segmentor 112 can generate a series of 2D segmentation masks for at least one (e.g., each) of the views where user inputs were provided. That is, the segmentor 112 can compare these segmented views with the original video data to determine the points where the segmented masks align with the captured trajectory. For example, the segmentor 112 can identify the frame in the video that corresponds to each segmented view and inject the segmentation mask into the video data at that point. In another example, the segmentor 112 can facilitate the alignment of the segmentation mask with the spatial properties of the 3D representation to maintain consistency.

In some implementations, the segmentor 112 can use a video tracker model to interpolate the 2D segmentation masks over a sequence of frames in the video data (e.g., a temporal propagation model that can maintain object consistency across frames, a recurrent network-based model that can use memory to recall various frames, a feature-matching model that can align segmented regions over time, or any model that applies learned tracking algorithms to interpolate 2D segmentation masks across sequences of frames in video data). That is, the video tracker of the segmentor 112 can propagate the segmentation mask (e.g., temporally) across frames, using the reference view as a permanent memory input to maintain identification of the segmented object throughout the video. For example, the segmentor 112 can input the segmented reference view and apply interpolation to project the segmentation onto the rest of the video frames. In another example, the segmentation mask can be adjusted dynamically to adapt to changes in object appearance across frames.

Additionally, the segmentor 112 can propagate the segmentation masks to the neural representations (e.g., 3D Gaussian splats) to facilitate the segmenting of the object of interest. That is, the segmentor 112 can freeze the 3D representation (e.g., Gaussian splat model) and update the 3D representation using the newly obtained segmentation masks to classify whether at least one (e.g., each) neural representation is part of the foreground object. For example, the updated Gaussian splats can carry binary values indicating the presence of the segmented object, allowing for further processing in subsequent stages. In another example, the segmentor 112 can repeat this process for multiple foreground objects in the scene, generating distinct segmentation outputs for at least one (e.g., each) object.

In some implementations, the segmentation stage can include a manual mode that uses the intersection of 2D bounding box queries to define regions of interest in the scene. That is, the user can define a bounding box in a 2D view that selects all 3D Gaussians whose centers project within the defined region for the current camera view (e.g., regardless of their depth in the 3D space). For example, a bounding box drawn around the one or more objects (e.g., doll, planter, tree) in one view can select all Gaussian splats representing parts of the objects as well as splats from objects behind, for example, the doll. In this example, subsequent queries can be performed by the segmentor 112 by rotating the camera to new views and defining additional bounding boxes to refine the selection. The intersection of these bounding boxes across different views can be used by the segmentor 112 to isolate the foreground object by removing background objects and retaining only the desired neural representations (e.g., Gaussian splats) that remain within the bounding box region across multiple views.

In some implementations, the segmentation stage can support iterative refinement by allowing the user to add, remove, or retain selections through multiple interaction steps. That is, at least one (e.g., each) interaction step can include defining a new bounding box query or adjusting an existing one, followed by the segmentor 112 recalculating the intersection of selected 3D Gaussians across the views. For example, a user can first select a rough region that includes the rag doll and its surrounding objects, then rotate the view to draw additional bounding boxes that exclude the undesired objects. In another example, the segmentor 112 can retain selected neural representations that remain consistently within the refined bounding boxes across all views while removing those that are outside any updated region. That is, the iterative process can continue until the segmentation accurately isolates the object of interest based at least in part on the user-defined queries and intersection terms.

In some implementations, the segmentation stage can include a semi-automatic mode that utilizes a combination of an image segmentation model and a video tracker model to provide more efficient and accurate segmentation with user guidance. That is, the semi-automatic mode can allow the user to interactively provide cues, such as clicks or selections, to guide the segmentor 112 (e.g., implementing the segmentation model) in distinguishing the object of interest from its background in a 2D view. For example, the segmentation model can process the user inputs to generate an initial segmentation mask that identifies the desired object within the frame. In another example, the user can change the view or perspective and provide additional inputs to further refine the segmentation mask, which can be used to account for variations in the appearance of the object across different angles. Additionally, the video tracker model can then use the reference segmentation mask to propagate the segmentation across subsequent frames.

The segmentor 112 can include any of one or more artificial intelligence models (e.g., machine learning models, supervised models, neural network models, deep neural network models), rules, heuristics, algorithms, functions, or various combinations thereof to perform operations including segmenting one or more objects or features of one or more objects from the data, such as from one or more frames of the data. In some implementations, the segmentor 112 can use the models to generate segmented masks or delineate object boundaries based at least in part on input data. For example, the segmentor 112 can employ various segmentation models to identify and isolate objects of interest in different frames or views, refining the segmentation boundaries across multiple perspectives as required. The segmentor 112 can utilize user inputs, such as clicks or bounding boxes, to guide the segmentation process.

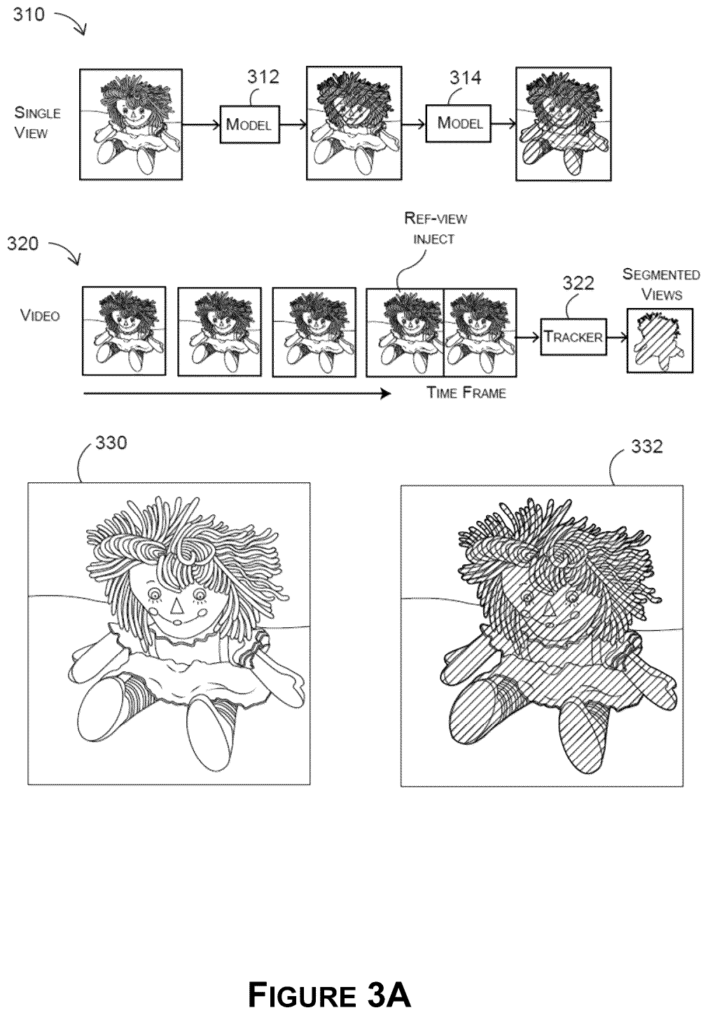

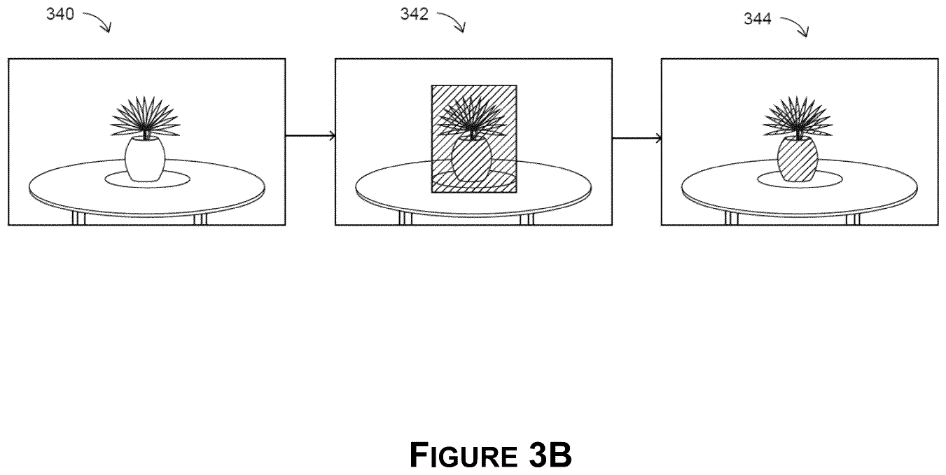

In some implementations, the segmentor 112 can maintain, execute, train, and/or update one or more machine-learning models during the segmentation stage. In some implementations, the machine-learning model(s) can include any type of image segmentation models configured to process frame data (e.g., image frames) to identify and segment objects. For example, the machine-learning model(s) can be trained and/or updated to process image frame inputs, accounting for variations in object appearance or perspective. The machine-learning model(s) can be or include a transformer-based model (e.g., encoder-decoder models) or other segmentation architectures for high-precision object delineation. The segmentor 112 can execute the machine-learning model to generate segmented outputs from the provided data. Segmentation is described in greater detail below with reference to FIGS. 3A-3B.

Referring further to FIG. 1, the system 100 can perform any of various preprocessing operations on the 3D representation output by the reconstructor 108 and segmented by the segmentor 112. For example and without limitation, during the preprocessing stage, the system 100 can perform inpainting, artifact removal, point sampling, or various combinations thereof on the 3D representation (e.g., neural representations, such as Gaussian splats. That is, inpainting can include filling gaps or holes in the object model by sampling data from nearby regions. For example, the preprocessor 116 can perform inpainting operations by sampling regions within a defined distance threshold from the segmented object. Additionally, artifact removal can include replacing poorly reconstructed areas. For example, the preprocessor 116 can discard or replace artifacts to improve the visual and structural integrity of the 3D representation.

In some implementations, the preprocessing stage can employ artifact processing based at least in part on artificial artifacts present in the 3D representation generated by the reconstructor 108 and segmented by the segmentor 112. That is, the preprocessing stage can include operations such as filling gaps, correcting poorly reconstructed regions, and/or removing incorrect or unnecessary shadows or artifacts. For example, the preprocessor 116 can perform inpainting to fill gaps in the object model (e.g., represented as Gaussian splats or other neural representations) by sampling from nearby, well-reconstructed regions within a defined distance threshold and/or using Gaussian splats from adjacent surfaces that have similar texture and lighting. In this example, inpainting can include the preprocessor 116 selecting Gaussian splats from an area (e.g., such as a clean area represented by a flat surface or uniform background) to cover regions that were unseen or poorly captured in the original training views. Additionally, the preprocessing stage can include the preprocessor 116 performing artifact removal where poorly reconstructed areas are replaced with sampled data from nearby regions to improve the visual and structural integrity of the 3D representation.

In some implementations, the preprocessing stage can use transformation techniques (e.g., affine transformations, non-rigid deformations, or any geometric transformation) to manipulate Gaussian splats, which can expose or reveal previously unseen regions to be corrected. That is, transformations such as translation, rotation, or scaling (e.g., affine transformations) can be used by the preprocessor 116 to modify the position or covariance of Gaussian splats, possibly exposing regions that were not visible in the training images. For example, translating an object upward can expose a section of the surface below it that was poorly reconstructed due to lack of visibility during the training phase. In another example, the preprocessor 116 can perform rotations of an object to uncover hidden artifacts that require immediate attention in preprocessing to maintain visual consistency.

In some implementations, the training phase can refer to the process where the system 100 is provided with a series of images or video frames of a scene from various viewpoints to build a 3D representation of the environment. During this phase, the system 100 can process the training images to create neural representations, such as Gaussian splats, which can capture the spatial and visual properties of the objects and surfaces in the scene. The training phase can include using the images to compute parameters such as the position, orientation, color, and depth information of the Gaussians that make up the 3D scene. After the training phase, the system 100 can perform stages where the pre-built 3D object model can be refined, prepared, and used in applications.

In some implementations, the preprocessor 116 can facilitate user-guided inpainting by allowing the user to mark or select a region to use as a sample for covering poorly reconstructed areas. That is, the user can interactively select regions that are well-reconstructed and instruct the preprocessor 116 to clone and paste Gaussian splats from these regions onto the exposed areas needing repair. For example, a user can identify a flat, well-textured area on a table surface near a region with visible artifacts and use it as the source for inpainting. In another example, the preprocessor 116 can automatically identify Gaussian splats within a certain distance threshold around the object and use these splats to fill gaps or replace erroneous regions.

In some implementations, the preprocessing stage can perform shadow removals in the Gaussian splats that were captured along with the object during initial training views. That is, shadows or color distortions that appear as artifacts in the 3D representation can be modified, updated, and/or removed. For example, if a segmented object, such as a doll, has shadows in the underlying surface Gaussians due to lighting conditions during capture, the preprocessor 116 can change the color of these Gaussians to remove the shadows. In another example, the preprocessing can include sampling color data from nearby unshadowed regions to provide consistent lighting across the 3D representation.

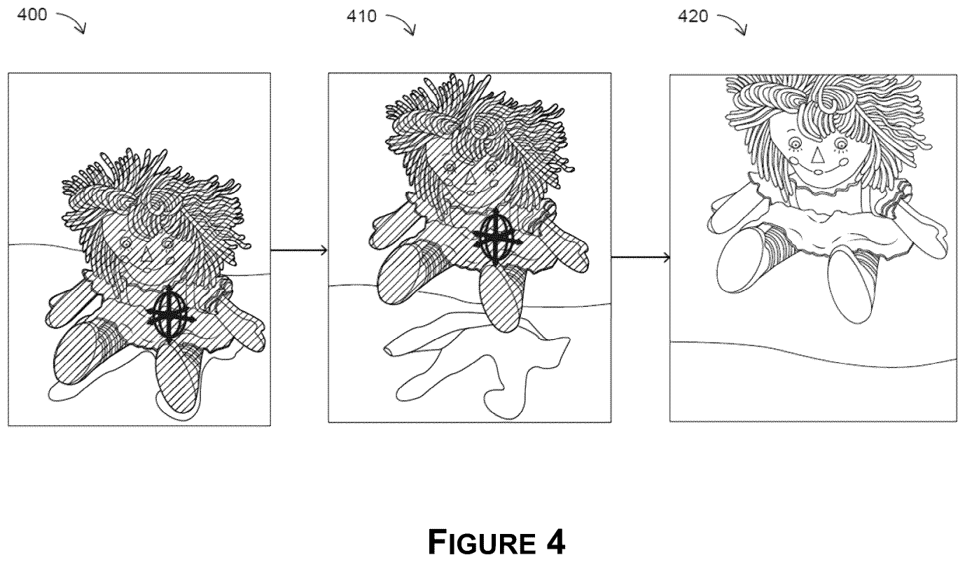

In some implementations, the preprocessor 116 can support multiple preprocessing actions and/or tasks to prepare the 3D representation for subsequent stages such as densification, simulation, and/or rendering. For example, the preprocessor 116 can first apply inpainting to repair poorly reconstructed regions, then proceed to perform shadow removal to ensure consistent lighting, and then perform artifact removal to address any remaining visual distortions. In another example, preprocessing can be prioritized based at least in part on the requirements of downstream processes, such as needing a smooth and artifact-free surface for accurate physics simulation. That is, by providing a 3D representation that can be free (or near-free) of artifacts and visually consistent, the system 100 can facilitate more accurate interaction and simulation of objects within the scene. For example, a preprocessed 3D model can improve the physics-based simulations where collisions and interactions are computed based at least in part on accurate geometry. Preprocessing is described in greater detail below with reference to FIG. 4.

In some implementations, the densification stage can refer to the stage in the 3D RCS pipeline in which the system 100 densifies the 3D representation to enhance volumetric mass accuracy. That is, the simulator 120 can sample a plurality of points on or around the segmented object to generate a voxelized volume based at least in part on the plurality of points. The densification stage can update the voxelized volume based at least in part on rendered depth maps. For example, the simulator 120 can perform depth carving to determine the occupancy state of voxels.

In some implementations, the densification stage can include converting the 3D Gaussian splats (3DGS) of the object representation into a dense voxel grid to simulate volumetric mass. That is, the densification stage can occur by the simulator 120 voxelizing the space around the segmented object to determine the occupancy of each voxel based at least in part on the presence of Gaussian splats. For example, the simulator 120 can use a CUDA-based Octree algorithm (e.g., accelerates the subdivision of space by using GPU processing power to create a hierarchical voxel grid from 3D Gaussian splats) to subdivide the space around the object into finer voxels, creating a hierarchical structure that efficiently represents the 3D occupancy. In this example, the axis-aligned bounding box of the Gaussian splats can be enclosed within a root node of the octree, which can be recursively subdivided into smaller nodes while maintaining a list of overlapping Gaussian splats for each sub-node. In some implementations, the simulator 120 can use a uniform grid-based framework and/or a voxel hashing technique. For example, a uniform grid-based approach can be used to divide the space into fixed-size voxels. In another example, voxel hashing can be used to dynamically allocates voxels in sparse regions.

In some implementations, the simulator 120 can use the voxelization process to output a high-resolution representation of the interior of the object. That is, the voxelization process can include subdividing nodes that contain Gaussian splats until the desired resolution is achieved, creating a grid representation (e.g., such as a Sparse Point Cloud (SPC), Dense Occupancy Grid, or any hierarchical voxel grid) that represents the voxels occupied by the splats. For example, the nodes at the frontier of the octree can form the voxelized shell of the object (e.g., voxel grid of voxels covering the approximated surface which are occupied), capturing the surface characteristics as represented by the neural representations. In another example, the voxelized shell does not include the interior voxels of the object, which can be further processed to provide a volumetric representation for accurate physics simulations.

In some implementations, the simulator 120, in the densification stage, can perform depth carving to fill the voxelized shell with volumetric mass, approximating a solid interior. That is, depth carving can include using rendered depth maps (e.g., rendered from an arrangement of virtual cameras) from multiple viewpoints to determine the occupancy state of each voxel within the shell. Additionally, the depth maps can be used to carve the space around the voxelized shell so that the dense volume of the object remains. For example, the simulator 120 can raytrace the Sparse Point Cloud (SPC) from a collection of viewpoints to generate depth maps that capture the distance (e.g., threshold distance) to the surface of the object from different angles. In another example, the depth maps can be fused together into a second sparse SPC, which can record the occupancy state for each voxel, such as empty, occupied, or unseen.

In some implementations, the simulator 120 can use the fused SPC to refine the voxelized volume by carving out unoccupied spaces and retaining the solid regions. That is, the simulator 120 can update the occupancy state of at least one (e.g., each) voxel based at least in part on the depth maps to create a volumetrically dense representation of the object. For example, the carving process can start from a fully occupied voxel grid and iteratively remove voxels that are determined to be empty based at least in part on their visibility in the depth maps. In this example, the carving can continue until only the occupied voxels that represent the solid shape of the object remain (e.g., filling the interior volume).

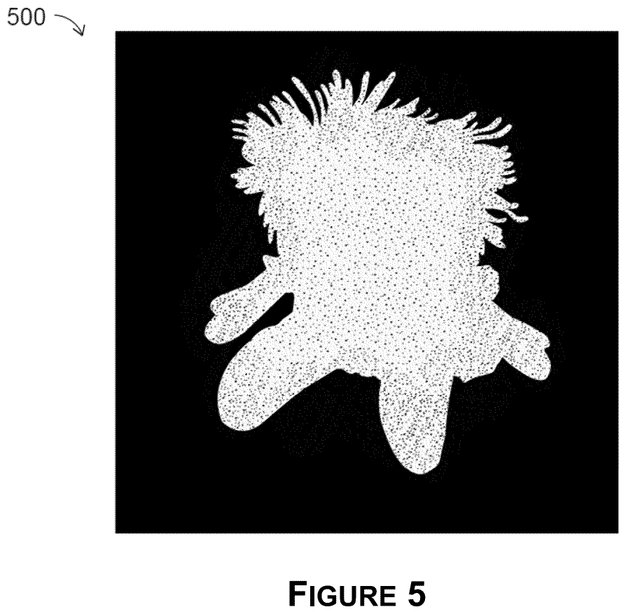

In some implementations, the densification stage can be used to ensure that the 3D representation is suitable for physics-based simulations (e.g., where accurate volumetric mass can be important). That is, the densified object representation can provide a realistic basis for simulating interactions, collisions, and physical behaviors. For example, once the densification stage is complete, the simulator 120 can accurately compute forces, torques, and deformations based at least in part on the solidified voxelized volume. In another example, the volumetric mass approximation provided can facilitate stable and realistic simulations. In some implementations, the densification stage can be optimized for performance and integrated as a dedicated component in software frameworks, such as NVIDIA's Kaolin. That is, the volume densification block can be implemented as a CUDA kernel that can perform the voxelization and depth carving processes. Densification is described in greater detail below with reference to FIG. 5.

In some implementations, the simulation stage can refer to the stage in the 3D RCS pipeline in which the system 100 simulates interactions of the voxelized volume. That is, the simulator 120 can inject a plurality of volumetric elements (e.g., isotropic Gaussians) in the interior of the voxelized volume to populate the interior. The simulator 120 can simulate one or more interactions of the voxelized volume of the densified object to update at least one physical attribute, such as rigidity or elasticity, of the object. The system 100 can include at least one simulator 120. The simulator 120 can include any one or more physics-based models, rules, heuristics, algorithms, functions, or various combinations thereof to perform operations including simulating one or more physical interactions (e.g., rigid body dynamics, elasticity) of the object. That is,

to simulate the one or more interactions of the voxelized volume, the one or more processors are to perform. For example, the simulator 120 can apply a first physics model to obtain a plurality of rigid motions and a second physics model to obtain a plurality of deformed states of the object. In some implementations, the simulator 120 can maintain, execute, train, and/or update one or more simulation models during the simulation stage. In some implementations, the simulation model(s) can include any type of physics-based simulation model configured for processing 3D representations to simulate physical behaviors. For example, the simulation model(s) can be trained and/or updated to process voxelized inputs. The simulation model(s) can be or include a physics engine model. The simulation model(s) can be configured to predict physical attributes such as deformation under forces.

The simulator 120 can include any of one or more physics-based models (e.g., mass-spring models, finite element models, neural network-based physics models), rules, heuristics, algorithms, functions, or various combinations thereof to perform operations including simulating physical interactions (e.g., rigid body dynamics, elasticity, fluid dynamics) of objects within the 3D scene. In some implementations, the simulator 120 can simulate object behaviors based at least in part on various physical properties such as mass, density, stiffness, and elasticity. For example, the simulator 120 can apply physics-based rules to compute interactions, deformations, and forces acting on the object. In another example, the simulator 120 can use neural network models to predict the physical behavior of objects and generate simulations based at least in part on training data. In some implementations, the simulator 120 can be trained independently from the models used by the segmentor 112. In some implementations, the simulator 120 can be trained jointly with the segmentor 112. The simulator 120 can be configured to perform both rigid and elastic simulations to model the physical behavior of objects in the scene.

The simulator 120 can include at least one physics model. The physics model can include input parameters (e.g., object properties), transformation parameters, and/or one or more intermediate layers, such as skinning fields, which at least one (e.g., each) can have respective control points. The system 100 can configure (e.g., train, update) the physics model by modifying or updating one or more parameters, such as weights and/or biases of various nodes of the physics model, based at least in part on evaluating estimated outputs. The simulator 120 can be or include various physics-based models effective for operating on or generating data including but not limited to object deformation, collision detection, or various combinations thereof. In some implementations, the simulator 120 can be configured (e.g., trained, updated, fine-tuned) based at least in part on training data derived from the 3D representation and segmentation results. For example, one or more example scenes of the training data can be applied as input to the simulator 120 to generate an estimated output. The estimated output can be evaluated and/or compared with one or more example outputs (e.g., using cost functions, objective functions, scoring functions), and the simulator 120 can be updated based at least in part on the evaluation and/or comparison. For example, based at least in part on an output of an objective function, one or more parameters (e.g., weights) of the simulator 120 can be updated.

Referring further to FIG. 1, the simulator 120 can receive and/or obtain one or more voxelized volumes of data (e.g., from performing densification) and can perform simulation operations (e.g., rigid or elastic simulation) on the voxelized volumes. For example, the simulator 120 can determine, based at least on a given voxelized volume, a representation (or a simulation result) of one or more interactions of the voxelized volume. The simulation representation can provide information related to the physical properties and/or behaviors of the segmented object.

In some implementations, the simulation stage can include simulating the physical interactions of voxelized volumes that represent the interior of segmented objects. That is, the simulator 120 can perform physics-based simulations by injecting a plurality of volumetric elements (e.g., isotropic Gaussians, cubature points, particle-based elements, or any volumetric representation) into the interior of the voxelized volume (e.g., created during densification) to populate the space with material properties for simulation. For example, the simulator 120 can simulate rigid body dynamics by treating the object as a rigid body with a control handle, allowing the entire object to move as a whole under external forces. In another example, the simulator 120 can simulate elastic deformations by using a method (e.g., deformation-based modeling, finite element analysis, or any physics-based simulation technique) to generate multiple control handles that guide the elastic properties and deformations of the object.

In some implementations, the simulator 120 can distinguish between (at least) two types of simulatable objects: rigid and elastic. That is, the simulator 120 can simulate rigid objects after segmentation, with the object being treated as a single entity with a defined mass and inertia. For example, the simulator 120 can apply external forces, such as gravity, to the rigid object and calculate the resulting motion based at least in part on the mass and other properties of the object. In another example, the simulator 120 can perform collision detection and response calculations to determine how the rigid object interacts with other objects in the scene. In some implementations, in elastic simulations, the simulator 120 can employ techniques such as energy minimization, optimization of deformation fields, and/or machine learning-based skinning methods to model the object with multiple control points and their associated weights.

In some implementations, the simulator 120 can utilize object parameters and scene parameters as inputs to simulate physical interactions. That is, object parameters can include the initial state of sampled cubature points, rest locations, and physical material properties such as stiffness, density, and/or elasticity modulus. For example, the cubature points can represent the interior volume of the object and provide the basis for simulating deformations and interactions. In another example, scene parameters can include external forces such as gravity, wind forces, and/or contact forces, which can be modeled as constraints that influence the potential energy of each cubature point. The simulator 120 can minimize the potential energy of the system by solving a Newton optimization problem (e.g., iterative gradient descent), determining how the object can deform under applied forces.

In some implementations, the simulator 120 can output a transformation that defines how the object can change over time. For example, the simulator 120 can compute a 12 Degrees of Freedom (DoF) affine transformation that determines how a plurality of (e.g., all, some) Gaussian positions and covariances of an object can transform at each time frame. For example, for rigid objects, the transformation can represent a combination of translation and rotation, which can be applied uniformly to neural representations (e.g., Gaussians) within the object. In another example, for elastic objects, the transformation can vary across different parts of the object, providing non-uniform deformations such as bending, stretching, or twisting. In some implementations, the simulator 120 can perform elastic simulations to animate Gaussian splats according to the computed transformations. That is, techniques such as Linear Blend Skinning (LBS), Dual Quaternion Skinning (DQS), Skeleton-based Deformation, and/or any mesh-based deformation technique can be used to perform elastic simulations. For example, the simulator 120 can use a deformation gradient obtained from LBS to transform both the Gaussian mean and covariance. For example, the skinning function can induce weights for each Gaussian, determining how strongly it can react to movement of a control point. In another example, the transformations can be used to simulate large elastic deformations, facilitating movements of the objects such as squashing, stretching, and twisting.

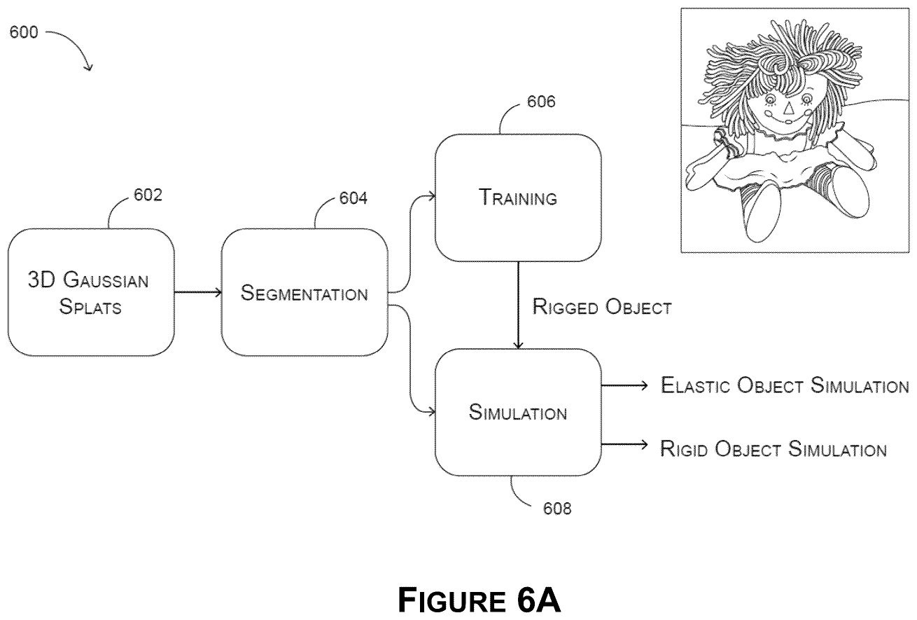

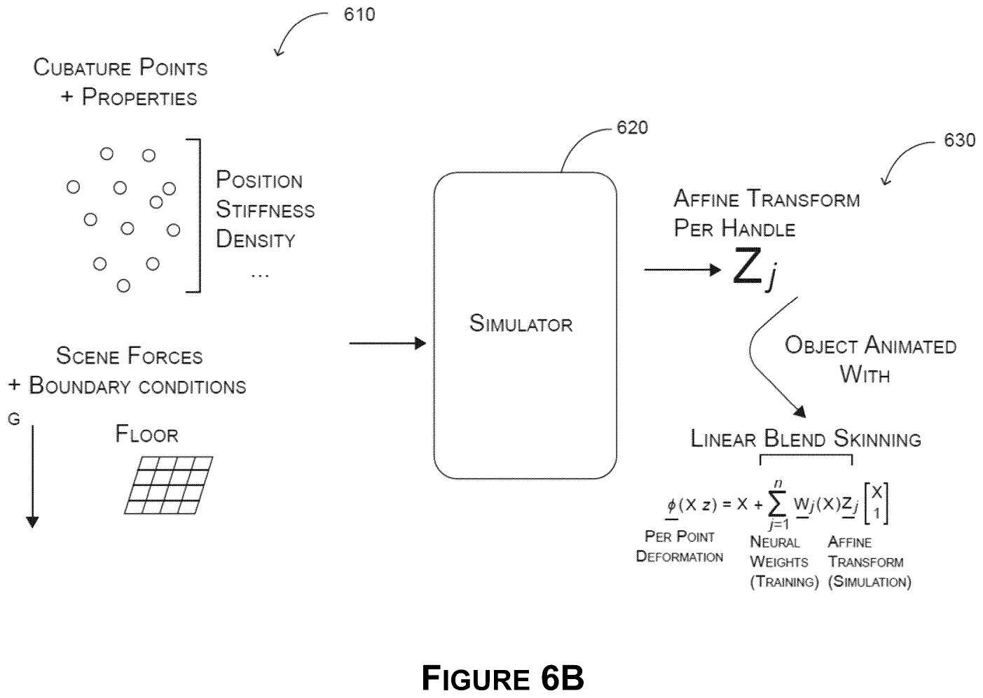

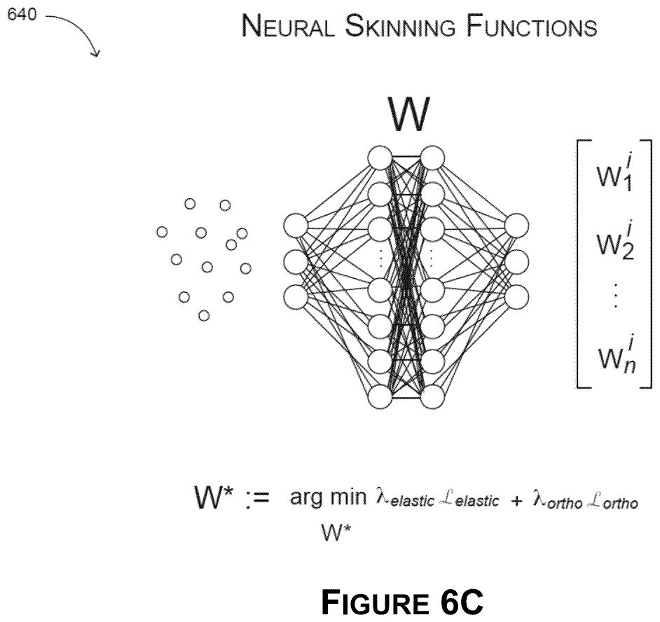

In some implementations, the simulator 120 can operate interactively, allowing users to influence the simulation by providing inputs (e.g., clicks, drags, selections). For example, users can interact with the simulated objects in real-time on an application (e.g., application 124), applying forces directly to the nearest neural representations (e.g., 3DGS) to simulate pull forces and/or push forces (e.g., gravity, wind, poking an object, etc.), rolling, jumping, or other interactions. In another example, a user can click and drag on a specific part of an elastic object to simulate a pulling motion, causing the object to deform accordingly. In yet another example, the interactive simulations can provide visual feedback in real-time (or near real-time). In some implementations, the simulator 120 can improve simulation runtimes by using precomputed data and efficient algorithms. That is, the simulator 120 can use techniques such as cached Hessians (e.g., precomputed second-order derivatives for energy minimization) to reduce the time for complex physics calculations. For example, using NVIDIA Warp, the simulator 120 can reduce the training time of the deformation modeling method(s) to 30-90 seconds per object, facilitating quick setup for elastic simulations. In another example, the optimization can allow the simulation to run online in an interactive mode, providing users with an improved experience when manipulating and testing different physical scenarios. Simulating is described in greater detail below with reference to FIGS. 6A-6C.

In some implementations, the display stage can refer to the stage in the 3D RCS pipeline in which data, including simulation outputs, is prepared for visualization or interaction. That is, the system 100 can generate at least one image of the 3D representation that depicts at least a portion of the at least one object for display. Generally, the at least one image can be a rendered frame showing the geometry, deformations, and simulated behaviors of the object and can be generated by applying rendering techniques such as rasterization, ray tracing, or neural rendering to the 3D representation. For example, the system 100 can use ray tracing to generate photorealistic images of the object under various lighting conditions or camera angles. That is, the system 100 can create visual outputs of different physical attributes or interactions of the object as simulated in the previous stages. Additionally, to generate the image, the system 100 can process data from the simulator 120, applying shaders and materials to enhance visual fidelity. For example, the system 100 can render the surface of the object with detailed textures, reflections, and shadows, providing a realistic view of the simulated interactions and deformations. That is, the rendered image can be displayed on a graphical user interface, allowing users to interact with or analyze the simulated object in various states and perspectives.

The system 100 can include or be coupled with at least one application 124. That is, at least one application 124 can manage the generation, rendering, and display of the object outputted from the pipeline. For example, the application 124 can facilitate the arrangement of output data from the segmentation model 112 and/or simulation model 120 into a structured format for rendering and presenting. In some implementations, the application 124 can function as a simulation management and visualization system for rendering and presenting the output from the 3D RCS pipeline. That is, the application 124 can generate (or render) and display simulation results (at least one image of a 3D representation) from the simulator 120 and converting the results into visual representations on a user interface (e.g., 3D visualization tool, interactive display panel, simulation dashboard, and/or any graphical user interface environment). For example, the application 124 can use GPU-accelerated rendering techniques to process the transformation matrices and deformation gradients generated during elastic or rigid body simulations. In this example, the application 124 can maintain a real-time data stream between the simulator 120 and the rendering system or device, providing for visualization updates when simulation parameters are modified.

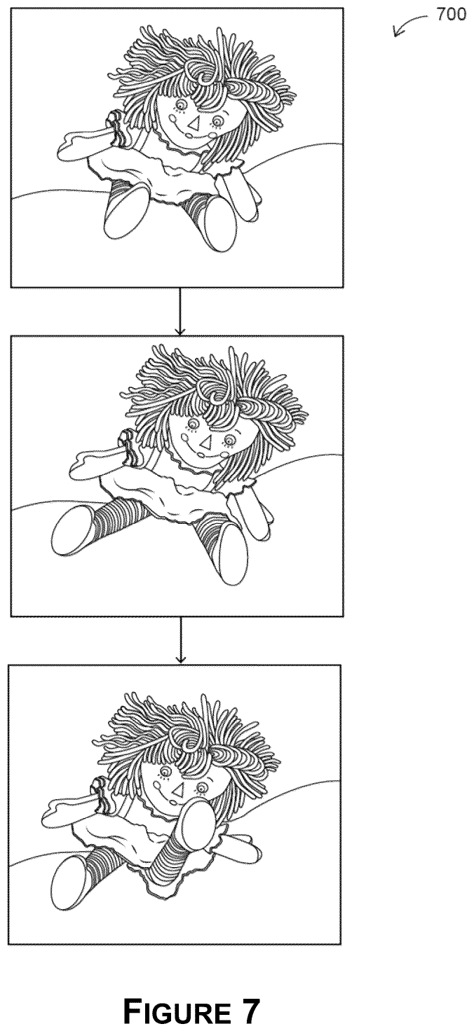

Additionally, the application 124 can perform interpolation and blending of simulation frames. In some implementations, the application 124 can provide a programmable environment that supports custom user inputs and real-time adjustments to simulation parameters. That is, the application 124 can expose an API or scripting layer that allows users to programmatically control simulation behaviors, modify physical properties, and/or introduce new force fields or constraints. For example, the application 124 can use shader programming and parallel computing techniques to adjust the rendering of neural representations based at least in part on deformation gradients computed by the simulator 120. In another example, the application 124 can facilitate collision detection and response calculations in parallel with the simulator 120. Displaying is described in greater detail below with reference to FIG. 7.

With reference to FIG. 2, a block diagram of an example reconstruction stage in an example pipeline is depicted, in accordance with some implementations of the present disclosure. For example, the reconstructor 108 can reconstruct, using at least One or more Gaussian splat representations and a depth map, the scene into a three-dimensional (3D) representation. That is, the initialization stage 200 can refer to the start of the reconstruction stage of the 3D RCS pipeline where the reconstructor 108 can generate initial representations of the scene using inaccurate camera poses and low-resolution depth maps at step 210. That is, the reconstructor 108 can receive and/or obtain inaccurate camera poses (e.g., providing rough estimates of the positions and orientations of the camera), and combine them with low-resolution depth maps to create initial Gaussian splat representations 220. For example, the low-resolution depth maps can provide sparse information about the depth of the scene, facilitating the approximation of the spatial structure with the initial Gaussian splat representations 220 by the reconstructor 108. In another example, the inaccurate camera poses at step 210 can be refined later during the training stage 250 to improve the accuracy of the reconstruction.

In some implementations, the reconstruction can be further based at least in part on at least one of (i) at least one refined pose of the video source and a plurality of two-dimensional (2D) frames of the video data. For example, the reconstruction can further include updating at least one initial pose (e.g., inaccurate camera poses) of the video source to the at least one refined pose based at least in part on aligning the 3D representation with the plurality of 2D frames of the video data. In this example, the aligning can include determining correspondence points between the 3D representation and 2D frames to improve (or optimize) camera positions. Additionally, the reconstructor 108 can generate an Gaussian splat representation (e.g., initialization phase—inputs: inaccurate camera poses, low-resolution depth maps; outputs: initial Gaussian splats) based at least in part on depth data of the depth map and the at least one initial pose of the video source. That is, the reconstructor 108 can compute the initial splat positions by projecting the depth values from the depth map into 3D space using the initial camera poses. In some implementations, the reconstructor 108 can generate a 3D reconstruction (e.g., training phase-inputs: initial Gaussian splats, RGB frames, and initial poses; output: refined 3D Gaussian splats) aligning with the 2D video frames using updated camera poses based at least in part on the initial Gaussian splat representation, the at least one refined pose of the video source, and the plurality of 2D frames. That is, the reconstructor 108 can improve (or optimize) the camera poses iteratively by minimizing the difference between projected splat positions and the corresponding 2D features in the video frames.

In some implementations, the training stage 250 can refer to the stage in the reconstruction stage of the 3D RCS pipeline where the reconstructor 108 can refine the initial Gaussian splat representations 220 generated during the initialization stage 200 using additional data, such as RGB frames 260 and updated camera poses. That is, the reconstructor 108 can use these RGB frames 260, which contain detailed color and texture information of the scene, along with refined camera poses to update the positions and orientations of the Gaussians. For example, during the training stage 250, the reconstructor 108 can optimize the Gaussians to better align with the RGB frames 260, leading to a more accurate reconstruction 270. In another example, the updated camera poses can provide improved geometric information to refine the placement of Gaussians, resulting in a 3D reconstruction 270 that captures both the appearance and structure of the scene more accurately. The training stage 250 enhances the initial outputs by leveraging both color data and refined geometric information, ultimately generating a high-fidelity 3D reconstruction 270 suitable for subsequent processing and simulation stages in the pipeline.

With reference to FIG. 3A, a block diagram of an example segmentation stage in an example pipeline is presented, in accordance with some implementations of the present disclosure. For example, the segmentor 112 can segment (e.g., identify and isolate an object from the 3D representation) at least one object in the 3D representation. The segmentation can include generating a two-dimensional (2D) segmentation mask (e.g., binary mask identifying specific regions corresponding to the object) of a reference view of the video data. Additionally, the segmentor 112 can interpolate (e.g., using a tracker 322) the 2D segmentation mask over a plurality of frames of the video data. Additionally, the segmentor 112 can map (e.g., associating 2D pixels in the mask with specific 3D regions of the scene) in a 3D representation from the scene.

In some implementations, the segmentor 112 can implement and/or use a segmentation model (e.g., segment anything model (SAM)). Additionally, the reference view can be based at least in part on a user input selecting the at least one object. For example, the user can guide the segmentation process by selecting an object of interest of a specific frame, such as being used as the reference view. In this example, the reference view can correspond to a frame (e.g., snapshot of the video serving as the reference view) of the plurality of frames of the video data.

In some implementations, the segmentation stage can refer to the stage in the 3D RCS pipeline where the segmentor 112 generates segmented views from video frames by incorporating both user input and segmentation models. That is, the segmentor 112 can perform with a single view process 310 (e.g., an image or frame) where a user selects an object within the frame. The segmentation model 312 can use these user selections to output a mask that identifies part of the object (e.g., the head). After this first segmentation, the user can perform another selection (or the system can automatically perform refinement) to further refine the segmentation. For example, selecting additional parts of the object (e.g., the body). That is, once the segmentation model 312 outputs this initial mask, another segmentation model 314 (or the same segmentation model 312) can be applied to segment the entire object. Additionally, the single view process 310 can segment a single image or frame, allowing users to make selections and apply segmentation to that specific image. In some implementations, a video process 320 can be performed on a plurality of frames, where a reference view can be selected by the user or automatically by the segmentor 112, and the tracker 322 can be applied across the video sequence. In some implementations, frame 330 depicts the object before any user selection, and frame 332 depicts the object highlighted after a user selection of the object to segment.

With reference to FIG. 3B, a block diagram of another example segmentation stage in an example pipeline is presented, in accordance with some implementations of the present disclosure. In some implementations, the segmentation stage can refer to the stage in the 3D RCS pipeline where the segmentor 112 isolates objects in different scenes using bounding box queries and 2D to 3D projection techniques to maintain segmentation across frames. That is, the segmentation can receive a view 340 of an object, such as a pineapple item, where the user defines a bounding box around the object to guide the segmentation model. The segmentor 112 can use the initial bounding box selection to create a mask 342 that segments the object within the defined region. For example, the segmentor 112 can utilize multiple bounding boxes from different views to facilitate occlusions or changes in perspective. In another example, the segmentor 112 can refine the segmentation by dynamically adjusting the bounding box 344 across different frames to maintain consistency even when the object appears in varying contexts or angles.

With reference to FIG. 4, a block diagram of an example preprocessing stage in an example pipeline is shown, in accordance with some implementations of the present disclosure. In some implementations, the preprocessor 116 can update at least one of the plurality of regions of the 3D representation within a threshold distance of the at least one object in the scene. That is, updating the at least one of the plurality of regions of the 3D representation within the threshold distance can be based at least in part on filling (e.g., inpainting) at least one of the plurality of regions within the threshold distance based at least in part on sampling data of one or more adjacent regions. Additionally, updating the at least one of the plurality of regions of the 3D representation within the threshold distance can be further based at least in part on removing one or more elements of at least one of the plurality of regions within the threshold distance and updating the at least one of the plurality of regions based at least in part on sampling data of one or more regions of the plurality of regions of the 3D representation.

In general, the preprocessing stage can refer to the stage in the 3D RCS pipeline where the preprocessor 116 can modify and enhance the segmented object(s) for further densification, simulation, and/or display. Additionally, the preprocessing stage can include identifying a segmented object in a rest view 400 (e.g., a doll) and apply transformation operations to adjust its position or orientation. For example, the preprocessor 116 can use a transformation tool to manipulate (e.g., or allow the user to manipulate using a user interface) the object in the scene, exposing previously unseen or poorly reconstructed areas, as shown in the adjusted view 410. In another example, after repositioning or scaling the object, the preprocessor 116 can perform inpainting or artifact removal to clean up any visual inconsistencies or artifacts revealed in the new position. The result can be a refined representation of the object in an updated view 420, where the preprocessor 116 corrected any visual errors and prepared the object for subsequent densification or simulation stages in the 3D RCS pipeline.

With reference to FIG. 5, a block diagram of an example densification stage in an example pipeline is depicted, in accordance with some implementations of the present disclosure. In some implementations, the simulator 120 can densify an object by sampling a plurality of points on or approximately around the at least one object. At a first step, the simulator 120 can generate (e.g., gaussians to voxels) a voxelized volume of the at least one object based at least in part on the plurality of points. At a second step, the simulator 120 can update (e.g., depth carving) the voxelized volume based at least in part on an occupancy state (e.g., occupied, semi-occupied, or not occupied) of at least one voxel of a plurality of voxels of the voxelized volume based at least in part on at least one rendered depth map. Additionally, the simulator 120 can populate an interior of the voxelized volume based at least in part on injecting a plurality of volumetric elements (e.g., isotropic gaussians) in the interior of the at least one object including a plurality of interior regions.

In some implementations, the densification stage in the 3D RCS pipeline can include the simulator 120 converting a set of 3D Gaussian splats into a dense voxel grid to simulate volumetric mass. That is, the simulator 120 can voxelize the Gaussian splats by using a hierarchical algorithm (e.g., a CUDA-based Octree, Kaolin's SPC) to subdivide the space around the object. For example, the simulator 120 can enclose the axis-aligned bounding box of the Gaussian splats within a cubical root node, which can be subdivided recursively (e.g., a 12-way, 8-way split, and/or 4-way split to create smaller nodes among other recursive processes). At least one (e.g., each) sub-node can maintain a list of overlapping Gaussians to represent the surface of the object. The subdivision can continue until the simulator 120 achieves a desired voxel resolution (e.g., 64×64×64, 128×128×128, or any user-defined resolution), resulting in a voxelized shell that captures the outer surface of the object.

In some implementations, the simulator 120 can fill the interior of the voxelized shell using depth maps generated from multiple viewpoints to generate the filled object shown in voxelized form in FIG. 5. That is, the simulator 120 can perform raytracing from various viewpoints (e.g., an icosahedral arrangement) to create depth maps of the object. The depth maps can be fused together to represent the internal structure of the object. For example, the simulator 120 can fuse these depth maps into a second sparse point cloud (SPC) and classify each voxel as either empty, occupied, or unseen based at least in part on the depth information. The simulator 120 can then carve away unoccupied voxels to refine the volumetric representation to create the filled object shown in voxelized form in FIG. 5. That is, the simulator 120 refines the interior by removing unoccupied spaces to create a volumetric representation with the remaining voxels reflecting the mass and structure of the object. As shown, the interior of the object can be densely packed with voxels, representing the volumetric properties of the object. For example, the densely packed voxels can represent the internal structure of object, with each voxel corresponding to depth information from multiple viewpoints.

With reference to FIG. 6A, a block diagram of an example simulation stage in an example pipeline is depicted, in accordance with some implementations of the present disclosure. In some implementations, the simulator 120 can simulate one or more interactions of the voxelized volume of the at least one densified object to update at least one physical attribute of the at least one object. For example, the at least one densified object can correspond to a volumetric representation. The reconstruction, segmentation, preprocessing, densification, and/or simulation process 300 can include the simulator 120 performing the training and simulation stages of the 3D RCS pipeline after the 3D Gaussian splats block 602 are processed through segmentation block 604 (and preprocessing), isolating the object for further operations. In some implementations, the simulator 120 can rig the object for simulation at training block 606. That is, during the training block 606, the simulator 120 can assign control points and neural weights to the object based at least in part on its geometry and material properties. In some examples, the simulator 120 can determine the influence of each control point over the surrounding Gaussians. The rigged object can then be output for simulation at simulation block 608.

In some implementations, the simulator 120 can apply physics-based simulations to the rigged object and/or directly to the segmented object. That is, after the segmentation block 604 (and/or after preprocessing), the simulator 120 can perform training on the object (e.g., where it is rigged with control points for more complex simulations) and/or it can directly perform simulations on the object. For example, when the object is rigged during training block 606, the simulator 120 can use control points and neural weights to provide elastic deformations or rigid body simulations (e.g., based at least in part on the material properties of the object). In some implementations, elastic simulations can include employing deformable model(s), simulating object movement (e.g., bending, stretching, compressing) under applied forces. In some implementations, rigid body simulations can include maintaining the structural integrity of the object and simulating movement as a single, solid unit. In both simulations, whether the object is rigged or not, the simulator 120 can calculate physics-based transformations, applying input forces (e.g., gravity or user interactions) to generate motion. For objects provided from the segmentation block 604 to simulation block 608, the simulator 120 can apply rigid body simulations, where the object is treated as a single entity. For rigged objects, the control points can allow for more deformations and elastic simulations. The output of the simulations can provide realistic movement and interaction, preparing the object for the next stages of rendering or additional physical manipulation in the 3D RCS pipeline.

With reference to FIG. 6B, a block diagram of an example rigid simulation stage in an example pipeline is presented, in accordance with some implementations of the present disclosure. In some implementations, simulating the one or more interactions can include performing a rigidity simulation. The rigidity simulation can include the simulator 120 applying, using a first physics model (e.g., rigid body dynamics, mass-spring systems, collision detection algorithms), a first plurality of transformations to the at least one densified object to obtain a plurality of rigid motions of the at least one densified object. That is, the transformation can be applied based at least in part on determining an energy function using at least one of a plurality of scene parameters (e.g., external forces such as gravity, and constraints such as boundary conditions) or a plurality of object parameters (e.g., physical properties of the object (i.e., initial state of sampled cubature points). Additionally, the transformation can include minimizing the energy function (e.g., minimize potential energy) to determine a plurality of rigid states of the at least one densified object. In some implementations, the transformation can include applying the plurality of rigid states to simulate the plurality of rigid motions of the at least one densified object over time.

In some implementations, the preparation stage 610 can include determining and/or defining the parameters for the rigid simulation. That is, the simulator 120 can receive and/or obtain input parameters that represent physical properties of the object, such as cubature points, material characteristics, and external forces. For example, cubature points can capture properties like position, stiffness, and density (e.g., initial rest positions, density values) and can be used to represent discrete points across the object. Scene forces can include a plurality of constraints and influences affecting the object, such as gravity and boundary conditions (e.g., gravitational fields, collision boundaries, static surfaces). Additionally, at least one (e.g., each) cubature point can be assigned a value representing the undisturbed configuration of the object before forces are applied.

The simulator 620 can model and/or determine transformations for the rigid object based at least in part on the prepared parameters. For example, the simulator 620 can employ methods such as optimization algorithms (e.g., Newton optimization, gradient descent, constraint satisfaction) to minimize the potential energy within the system. That is, the simulator 120 can calculate the transformation for at least one (e.g., each) control handle, representing movements such as translations, rotations, or scaling (e.g., 12 degrees of freedom (DoF), 6 DoF transformations, affine transformations). For example, the simulator 120 can apply one or more transformations to simulate the motion of mechanical components, such as robotic arms or articulated machinery. In this example, the motion can be simulated on one or more individual sections independently while preserving the overall rigidity of the object. In some implementations, the simulator 620 can use a per-point deformation formula (shown below) that combines neural weights trained during the preparation stage with affine transformations computed in simulation (per-point deformation formula):

$$\underline{ϕ} ( X z ) = X + {\sum }_{j = 1}^{n} \underline{{W}_{j}} ( X ) \underline{{Z}_{j}} [ \begin{matrix}X \\ 1\end{matrix} ]$$

In some implementations, the simulator output 630 can include a combined set of transformations for the object. The combined set can be animated using Linear Blend Skinning (LBS) techniques. That is, LBS can interpolate the per-handle transformations Zⱼ across cubature points. For example, LBS can be used to animate rigid components in various examples, such as industrial machines, articulated vehicles, and/or interconnected parts. The formula for per-point deformation integrates the influence of at least one (e.g., each) control handle by applying a weighted sum of affine transformations, facilitated by the neural weights obtained during training. That is, the per-point deformation formula is used such that the object can retain its structural coherence (e.g., the points reacting to movements directed by the control handles).

In general, training in the simulation process can include calculating neural weights for control handles associated with cubature points to establish deformation and movement characteristics of the object. During training, the simulator 120 can iteratively adjusts the neural weights based at least in part on perturbations applied to control points, using optimization techniques (e.g., gradient descent, Newton method) to minimize a predefined objective function, such as deformation error or potential energy. The influence of at least one (e.g., each) control handle on surrounding cubature points can be quantified by the neural weights (e.g., defining how movements or forces applied to the handle will propagate across the geometry of the object). For example, in rigid simulations, the training phase can be used to ensure that transformations applied to specific handles, such as moving or rotating the arm of a machine, are reflected throughout the connected regions while maintaining structural integrity. That is, the training can output in a set of neural weights that can be applied during the simulation stage, allowing the simulator 120 to animate the object with high fidelity based at least in part on the learned control points and their corresponding influence zones.

The simulator 120 can also provide interactive simulations, allowing users to influence the simulation by manipulating control handles or adjusting parameters in real-time (or near real-time). That is, users can update or modify inputs such as external forces or a time slider (e.g., apply directional forces, set constraints, modify simulation speeds) to observe the response of the object under various conditions. For example, users can simulate the independent movement of specific parts of a rigid object (e.g., adjusting the arm of a digger while the body remains stationary, to observe the distribution of transformations across the object). That is, the simulator 120 can apply the computed transformations using the per-point deformation formula, incorporating neural weights and affine transformations to animate the object accurately.

With reference to FIG. 6C, a block diagram of an example elasticity simulation stage in an example pipeline is presented, in accordance with some implementations of the present disclosure. In some implementations, simulating the one or more interactions of the object can include performing an elasticity simulation (e.g., elastic simulation: simulate the movement and behavior of the densified object)). The elasticity simulation can include the simulator 120 applying, using a second physics model (e.g., finite element model, mass-spring system, or any mesh-free method), a plurality of transformations to the at least one densified object to obtain a plurality of deformed states of the at least one densified object. That is, the transformation can include determining an energy function using at least one of a plurality of scene parameters or a plurality of object parameters. Additionally, the transformation can include minimizing the energy (e.g., minimize potential energy) function to determine a plurality of updates to a plurality of control points. The transformation can further include calculating one or more deformations (e.g., animate the objects Gaussians) of the at least one densified object based at least in part on the plurality of updates to the plurality of control points (e.g., points that control the deformation) and a plurality of corresponding skinning fields (e.g., learned weights used to determine how the control points affect the deformation of the object—the skinning fields can be cleared from deformation gradients).

In some implementations, the simulator 120 can perform elastic simulations by using a neural network (e.g., feedforward neural network, convolutional neural network, recurrent neural network) to model and/or compute a set of neural weights

$${W}_{1}^{i} , {W}_{2}^{i} , … , {W}_{n}^{i}$$

that define the influence of each control handle on the deformation of the object. That is, at least one (e.g., each) control handle can correspond to a Gaussian point or set of points, and the neural skinning functions can be used by the simulator 120 to determine how strongly (e.g., magnitude, radius of influence, degree of deformation) a handle affects the movement of the surrounding Gaussians. For example, the neural weights

$${W}_{1}^{i}$$

can be optimized to minimize an objective function that includes both an elastic loss term and an orthogonality loss term. In another example, the neural weights can be applied to various elastic models (e.g., Linear Blend Skinning, Dual Quaternion Skinning, Spline-Based Deformations) to simulate different material properties (e.g., rubber-like elasticity or flexible fabric behavior).

The training phase for these neural weights can include the simulator 120 implementing self-supervision. For example, small perturbations can be applied to the control points, and the resulting deformations can be used to refine the weight values. For example, the simulator can perform the small perturbations to determine the optimal weight field W* that minimizes the combined loss function:

$${W}^{*} := arg min ( {λ}_{elastic} {ℒ}_{elastic} + {λ}_{ortho} {ℒ}_{ortho} )$$

where [symbol] _{elastic} refers to the energy needed to deform the object elastically, [symbol] ₒᵣₜₕₒ refers to ensuring the deformations are orthogonal to each other (e.g., to prevent unnatural movement), λ_{elastic} refers to a target deformed position of the object points under elastic forces, and λₒᵣₜₕₒ refers to a constraint for maintaining orthogonality between deformation modes (e.g., one deformation does not interfere with other deformations). In some implementations, the training process can be accelerated using numerical gradient computation or NVIDIA Warp (e.g., reducing training time to 30-90 seconds per object). That is, after neural skinning functions are trained, the functions can define a rigging handle for each Gaussian, facilitating the accurate and efficient simulations of elastic behaviors.

With reference to FIG. 7, a block diagram of an example simulation of an object in an example pipeline is shown, in accordance with some implementations of the present disclosure. FIG. 7 depicts an interactive simulation mode 700 where the application 124 and/or simulator 120 can be used to simulate user interactions with an object represented by Gaussian splats. That is, the application 124 can process user inputs such as clicks and drags to apply localized forces (e.g., pull forces, twist forces, push forces) to the nearest Gaussians, causing the object to deform or move in response to the applied forces. For example, as shown in FIG. 7, the user can interactively manipulate the doll by clicking and dragging on different parts of its body, with the application 124 and/or simulator 120 applying corresponding forces to generate realistic movements and deformations of the doll in the scene. The interactive simulation mode 700 can use the computation configurations of the application 124 and/or simulator 120 to provide real-time feedback.

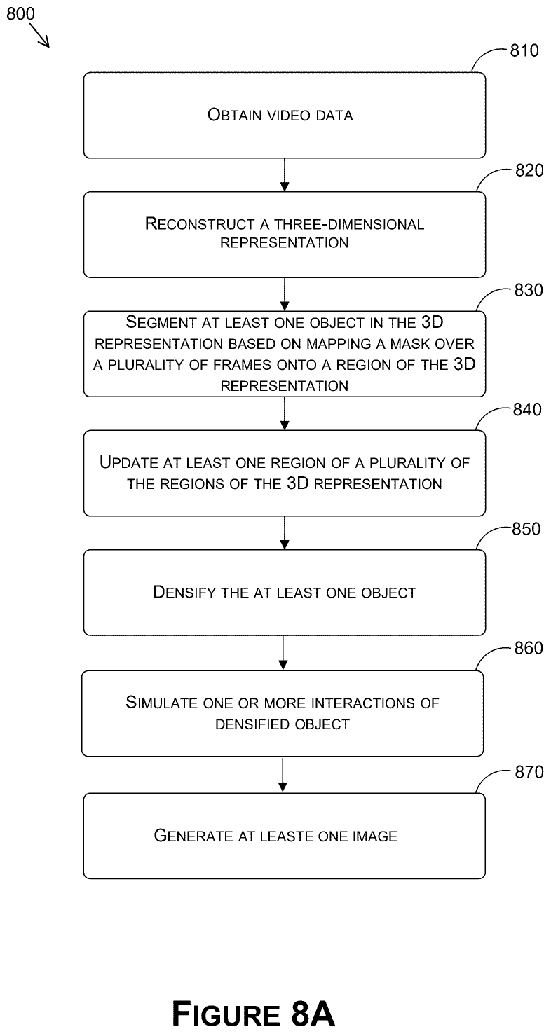

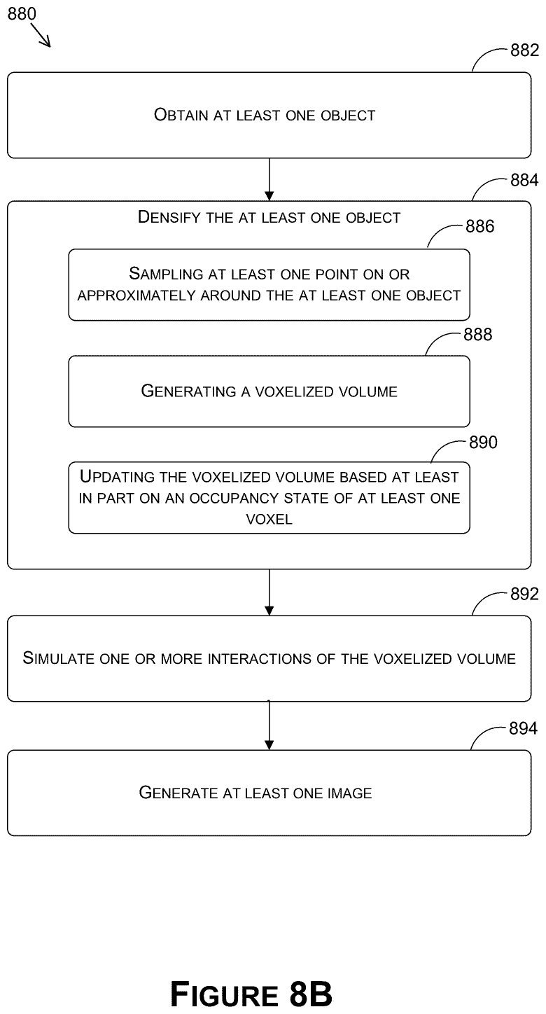

With reference to FIG. 8A, an example flow diagram illustrating a method for scene reconstruction, segmentation, preprocessing, densification, and/or simulation in an example pipeline is depicted, in accordance with some implementations of the present disclosure. It should be understood that this and other arrangements described herein are set forth only as examples. Other arrangements and elements (e.g., machines, interfaces, functions, orders, groupings of functions, etc.) can be used in addition to or instead of those shown, and some elements can be omitted altogether. Further, many of the elements described herein are functional entities that can be implemented as discrete or distributed components or in conjunction with other components, and in any combination and location. Various functions described herein as being performed by entities can be carried out by hardware, firmware, and/or software. For example, various functions can be carried out using one or more processor executing instructions stored in one or more memories. For example, in some implementations, the system and methods described herein can be implemented using one or more generative language models (e.g., as described in FIGS. 9A-9C), one or more computing devices or components thereof (e.g., as described in FIG. 10), and/or one or more data centers or components thereof (e.g., as described in FIG. 11).

Now referring to FIG. 8A, each block of method 800, described herein, includes a computing process that can be performed using any combination of hardware, firmware, and/or software. For example, various functions can be carried out using one or more processors executing instructions stored in one or more memories. The method can also be embodied as computer-usable instructions stored on computer storage media. The method can be provided by a standalone application, a service or hosted service (standalone or in combination with another hosted service), as a microservice via an application programming interface (API) or a plug-in to another product, to name a few. In addition, method 800 is described, by way of example, with respect to the system of FIG. 1. However, this method can additionally or alternatively be executed by any one system, or any combination of systems, including, but not limited to, those described herein.

FIG. 8A is a flow diagram showing a method 800 for scene reconstruction, segmentation, preprocessing, densification, and/or simulation in an example pipeline, in accordance with some implementations of the present disclosure. The method 800, at block 810, includes receiving (e.g., by reconstructor 108), from a video source (e.g., video source 104), video data including a depth map of a scene. For example, the video data can be captured RGB frames including camera information, such as intrinsics and poses. Additionally, the depth map can provide depth information for one or more (e.g., each) pixel.

The method 800, at block 820, includes reconstructing (e.g., by reconstructor 108) the scene into a three-dimensional (3D) representation (e.g., neural representations, 3D gaussian splats). For example, at least One or more Gaussian splat representations can be used to reconstruct the scene as a series of Gaussian distributions (splats). In another example, the depth map can be converted into a point cloud to generate the 3D Gaussian splats. In some implementations, during an initialization phase of reconstruction the processing circuits can generate an initial Gaussian splat representation based at least in part on depth data of the depth map and the at least one initial pose of the video source. For example, inaccurate camera poses and low-resolution depth maps can be used to output the initial Gaussian splats. In some implementations, during a training phase (after initialization) of reconstruction, the initial Gaussian splat representation and RGB frames and optimized camera pose can be inputted to obtain (or receive) a 3DGS reconstruction. For example, the 3DGS reconstruction can be based at least one of (i) at least one refined pose of the video source and a plurality of two-dimensional (2D) frames of the video data. That is, the 3D reconstruction can be aligned with the 2D video frames using updated camera poses based at least in part on the initial Gaussian splat representation (initial Gaussian), the at least one refined pose of the video source, and/or the plurality of 2D frames. Additionally, the processing circuits can update at least one initial pose (e.g., inaccurate camera poses) of the video source to the at least one refined pose based at least in part on aligning the 3D representation with the plurality of 2D frames of the video data.

The method 800, at block 830, includes segmenting (e.g., by segmentor 112) at least one object in the 3D representation and/or segmentation data corresponding to the at least one object. That is, the processing circuits can identify and isolate an object from the 3D representation. Segmenting can include generating a two-dimensional (2D) segmentation mask (e.g., binary mask identifying specific regions corresponding to the object) of a reference view of the video data. Additionally, segmenting can include interpolating the 2D segmentation mask over a plurality of frames of the video data. For example, the processing circuits can maintain consistency across frames by applying the 2D segmentation mask on a plurality of views. In this example, the mask can indicate which pixels in the image is the object or the background. In some implementations, segmenting can include mapping the 2D segmentation mask over the plurality of frames onto at least one corresponding region of a plurality of regions of the 3D representation to segment the at least one object (e.g., in the 3D representation of the scene) and/or segmentation data (e.g., corresponding with the at least one object). For example, the processing circuits can associate 2D pixels in the mask with specific 3D regions of the scene (e.g., each pixel can correspond to a location in 3D space). In this example, the processing circuits can identify which Gaussian splats correspond to the object in 3D space. In some implementations, segmenting can include using a segmentation model (e.g., segment anything model (SAM). Additionally, the reference view can be based at least in part on a user input. For example, the user can guide the segmentation process by selecting (or performing multiple selections) an object (or portions of the object) of interest of a specific frame. In this example, the reference view can correspond to a frame (e.g., snapshot of the video serving as the reference view) of the plurality of frames of the video data.

The method 800, at block 840, includes updating (e.g., by preprocessor 116) at least one of the plurality of regions of the 3D representation within a threshold distance of the at least one object in the scene. For example, the 3D gaussian splat regions can be preprocessed by performing inpainting and artifact removal. In some implementations, the processing circuits can fill at least one of the plurality of regions within the threshold distance based at least in part on sampling data of one or more adjacent regions. For example, the processing circuits can perform inpainting by filling gaps and/or holes in the object model by sampling data from nearby regions. In some implementations, the processing circuits can remove one or more elements of at least one of the plurality of regions within the threshold distance. That is, poorly reconstructed areas can be discarded or replaced. Additionally, removal can include updating the at least one of the plurality of regions based at least in part on sampling data of one or more regions of the plurality of regions of the 3D representation.

The method 800, at block 850, includes densifying (e.g., by simulator 120) the at least one object by sampling a plurality of points on or approximately around the at least one object. For example, the processing circuits can convert sampled Gaussian splats into a voxel grid to represent the structure of the object. Additionally, densifying can include generating (e.g., step 1: gaussians to voxels) a voxelized volume of the at least one object based at least in part on the plurality of points. That is, the processing circuits can subdivide the space around the object into voxels, creating a structured representation of the 3D space. In some implementations, densifying can further include updating (e.g., step 2: depth carving) the voxelized volume based at least in part on an occupancy state of at least one voxel of a plurality of voxels of the voxelized volume based at least in part on at least one rendered depth map. For example, the processing circuits can remove unoccupied voxels by comparing voxel positions to depth map values, refining the volume to match the geometry of the object. The processing circuits can populate an interior of the voxelized volume based at least in part on injecting a plurality of volumetric elements (e.g., isotropic Gaussians, particles, or any discrete sampling) in the interior of the at least one object including a plurality of interior regions. That is, the volumetric elements can be injected for performing the simulations at block 860.

The method 800, at block 860, includes simulating (e.g., by simulator 120) one or more interactions of the voxelized volume of the at least one densified object to update at least one physical attribute of the at least one object. That is, the at least one densified object can correspond to a volumetric representation (e.g., provided during densification at block 850). In some implementations, simulating the one or more interactions can include performing a rigidity simulation (e.g., rigid simulation, simulating the movement and behavior of the densified object). That is, the simulation can include the processing circuits applying, using a first physics model, a first plurality of transformations to the at least one densified object to obtain a plurality of rigid motions of the at least one densified object. For example, applying the transformation can be based at least in part on the processing circuits determining an energy function using at least one of a plurality of scene parameters (e.g., external forces such as gravity, and constraints such as boundary conditions) or a plurality of object parameters (e.g., physical properties of the object, such as an initial state of sampled cubature points). In this example, applying the transformation can be further based at least in part on the processing circuits minimizing the energy function (e.g., minimize potential energy) to determine a plurality of rigid states of the at least one densified object. Additionally, applying the transformation can be further based at least in part on the processing circuits applying the plurality of rigid states to simulate the plurality of rigid motions of the at least one densified object over time.

In some implementations, simulating the one or more interactions can include performing an elasticity simulation (e.g., elastic simulation, simulating the movement and behavior of the densified object). That is, one or more operations to simulate the one or more interactions includes at least one operation to perform an elasticity simulation includes applying, using a second physics model, a second plurality of transformation to the at least one densified object to obtain a plurality of deformed states of the at least one densified object. For example, the simulation can include the processing circuits applying, using a second physics model, a second plurality of transformations to the at least one densified object to obtain a plurality of deformed states of the at least one densified object. For example, applying the transformation can be based at least in part on the processing circuits determining an energy function using at least one of a plurality of scene parameters or a plurality of object parameters. In this example, applying the transformation can be further based at least in part on the processing circuits minimizing the energy (e.g., minimize potential energy) function to determine a plurality of updates to a plurality of control points. Additionally, applying the transformation can be further based at least in part on the processing circuits calculating one or more deformations (e.g., animate the objects Gaussians) of the at least one densified object based at least in part on the plurality of updates to the plurality of control points (e.g., points that can control the deformation) and a plurality of corresponding skinning fields (e.g., learned weights used to determine how the control points affect the deformation of the object).

The method 800, at block 870, includes generating at least one image of the 3D representation that depicts at least a portion of the at least one object for display. In some implementations, the processing circuits can generate for display (e.g., on application 124) the at least one object. For example, generating can include rendering the voxelized volume or 3D Gaussian splat representation of the object into a visual output from multiple viewpoints to capture different angles and aspects of the structure and behavior of the object. In this example, the at least one image can be a sequence of frames showing the deformations and interactions of the object over time, and the 3D representation can be a model incorporating physical properties and simulated effects. That is, the processing circuits can generate (e.g., render) the simulated object for visualization or interaction on a user interface. For example, the application 124 can generate for display the object in various states based at least in part on the simulation results, allowing the user to observe the behavior of the object under different conditions. In some implementations, generating can include using rendering techniques such as shadow mapping or global illumination to enhance the realism of the visual output. Additionally, the display can facilitate updates or modifications by a user. For example, the user can modify simulation parameters or apply new forces to the object to see how the object reacts. That is, the processing circuits can update the visual representation in real-time based at least in part on the inputs of the user.

Disclosed implementations can be included in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), neural representation techniques, diffusion models, transformer models, etc.), systems implemented at least partially in a data center, systems for performing conversational AI operations, systems implementing one or more language models-such as one or more large language models (LLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

With reference to FIG. 8B, an example flow diagram illustrating a method for object densification and/or simulation in an example pipeline is presented, in accordance with some implementations of the present disclosure. It should be understood that this and other arrangements described herein are set forth only as examples. Other arrangements and elements (e.g., machines, interfaces, functions, orders, groupings of functions, etc.) can be used in addition to or instead of those shown, and some elements can be omitted altogether. Further, many of the elements described herein are functional entities that can be implemented as discrete or distributed components or in conjunction with other components, and in any combination and location. Various functions described herein as being performed by entities can be carried out by hardware, firmware, and/or software. For example, various functions can be carried out using one or more processor executing instructions stored in one or more memories. For example, in some implementations, the system and methods described herein can be implemented using one or more generative language models (e.g., as described in FIGS. 9A-9C), one or more computing devices or components thereof (e.g., as described in FIG. 10), and/or one or more data centers or components thereof (e.g., as described in FIG. 11).

Now referring to FIG. 8B, each block of method 880, described herein, includes a computing process that can be performed using any combination of hardware, firmware, and/or software. For example, various functions can be carried out using one or more processors executing instructions stored in one or more memories. The method can also be embodied as computer-usable instructions stored on computer storage media. The method can be provided by a standalone application, a service or hosted service (standalone or in combination with another hosted service), as a microservice via an application programming interface (API) or a plug-in to another product, to name a few. In addition, method 880 is described, by way of example, with respect to the system of FIG. 1. However, this method can additionally or alternatively be executed by any one system, or any combination of systems, including, but not limited to, those described herein.

FIG. 8B is a flow diagram showing a method 880 for object densification and/or simulation in an example pipeline, in accordance with some implementations of the present disclosure. The method 880, at block 882, includes receiving at least one object (e.g., segmentation data corresponding to the at least one object) segmented from video data. That is, the process circuits can receive and/or obtain (or identify) a 3D representation of the segmented object (e.g., a Gaussian splat representation and/or neural representation). For example, the segmented object can be represented by a set of Gaussian splats corresponding to its surface structure. In some implementations, the segmented object can include metadata, such as object boundaries and pose information. For example, the object metadata can include camera poses and depth information used during reconstruction and segmentation.

The method 880, at block 884, includes densifying the at least one object (e.g., of segmentation data corresponding to the at least one object). In general, the densification can include converting a set of 3D Gaussian splats into a dense voxel grid to simulate volumetric mass. That is, the processing circuits can inject a plurality of volumetric elements (e.g., isotropic Gaussians) into the interior of the voxelized volume, filling in regions that were previously hollow to create a solid representation. For example, the processing circuits can use a hierarchical voxelization method (e.g., CUDA-based Octree, Kaolin's SPC) to subdivide the space around the object into a structured voxel grid, capturing both the surface and interior of the object. In some implementations, the processing circuits can initialize the voxelization by enclosing the axis-aligned bounding box of the Gaussian splats within a cubical root node (e.g., which can be recursively subdivided into finer nodes.) Additionally, the voxel grid can be updated based at least in part on occupancy states determined from depth maps rendered from multiple viewpoints. For example, the processing circuits can perform depth carving to refine the voxel grid, removing unoccupied voxels based at least in part on the rendered depth map information. In some implementations, the outputted voxelized volume can provide a high-resolution representation of the object (e.g., to be provide for physics simulations).

The method 880, at block 886, includes sampling a plurality of points on or approximately around the at least one object. That is, the processing circuits can sample points on or around the object to generate a grid of voxels representing the structure of the object. For example, the processing circuits can distribute sampled points uniformly across the surface and within its interior, creating a voxelized representation that captures the geometric and volumetric properties of the object. In some implementations, the processing circuits can use Gaussian splats as sampling points to generate the voxel grid, converting the splats into voxels based at least in part on their positions and covariances. Additionally, the sampling process can be refined to achieve a desired resolution for the voxelized volume. For example, the processing circuits can adjust the sampling density to ensure that the voxel grid accurately represents the surface and internal features of the object. In some implementations, the voxelized volume can be further refined by aligning the sampled points with depth maps rendered from different viewpoints.

The method 880, at block 888, includes generating a voxelized volume of the at least one object based at least in part on the plurality of points. That is, the processing circuits can generate a structured voxel grid representing the geometry of the object based at least in part on the sampled points. For example, the processing circuits can assign at least one (e.g., each) point to a voxel based at least in part on its position and covariance, creating a dense grid that captures both surface and interior features of the object. In some implementations, the processing circuits can generate a voxelized shell of the object by defining the boundaries of each voxel based at least in part on the positions of the Gaussian splats. Additionally, the processing circuits can adjust the resolution of the voxel grid to achieve a desired level of detail. For example, the processing circuits can subdivide the voxel grid into smaller nodes to refine the representation of some regions (e.g., complex, highly pixelated). In some implementations, the processing circuits can use a hierarchical voxel grid to store the generated volume.

The method 880, at block 890, includes updating the voxelized volume based at least in part on an occupancy state of at least one voxel of a plurality of voxels of the voxelized volume based at least in part on at least one rendered depth map. That is, the processing circuits can determine the occupancy state of each voxel based at least in part on depth information obtained from multiple viewpoints. For example, the processing circuits can perform raytracing from an icosahedral arrangement of viewpoints to generate depth maps that capture the threshold distance to the surface of the object from different angles. In some implementations, the processing circuits can fuse one or more depth maps to classify each voxel as occupied, empty, or unseen, refining the voxelized volume to match the geometry of the object. Additionally, the processing circuits can update the voxelized volume by removing unoccupied voxels based at least in part on the depth map values. For example, the processing circuits can use a sparse point cloud (SPC) representation to store the occupancy states of the voxels. In this example, the SPC can allow for efficient querying and manipulation of the voxelized volume.

The method 880, at block 892, includes simulating one or more interactions of the voxelized volume of the at least one densified object to update at least one physical attribute of the at least one object. That is, the processing circuits can simulate interactions such as deformation, collision, or movement based at least in part on the material properties and external forces of the object. For example, for an elastic object the processing circuits can simulate deformations using control points and/or neural weights to animate the object based at least in part on input forces such as gravity or user interactions. In another example, for a rigid object the processing circuits can simulate rigid body dynamics by applying a set of affine transformations to the voxelized representation of the object (e.g., solid object). In some implementations, the processing circuits can use different physics model(s) for rigid and elastic simulations, adjusting parameters such as stiffness, density, or external forces. Additionally, the simulation results can include updates to the position, orientation, and shape over time of the object. For example, the processing circuits can animate the object using methods such as linear blend skinning or dual quaternion skinning to visualize the simulated interactions. In another example, the processing circuits can generate visual outputs that depict the simulated behavior of the object under different conditions.

The method 880, at block 894, includes generating at least one image of the 3D representation that depicts at least a portion of the at least one object for display. That is, the at least one object can be displayed. For example, generating can include rendering the voxelized volume or 3D Gaussian splat representation of the object into one or more images from various viewpoints. In this example, the at least one image can be a rendered frame depicting the geometry, material properties, and any simulated interactions of the object, and the 3D representation can be a visual model of the object with textures and lighting effects. That is, the processing circuits can generate (or render) and display the simulated object within a graphical user interface or visualization platform. In some implementations, generating can include using photorealistic rendering techniques, such as ray tracing or path tracing. For example, the processing circuits can visualize the state of the object at one or more time frames, depicting deformations, movements, or other physical changes. In some implementations, the display can include interactive features, allowing users to manipulate the object, change simulation parameters, or view the simulation from different perspectives. Additionally, the processing circuits can update the visualization in real-time as one or more simulations progress. For example, the display can depict comparative views of different simulation outcomes, highlighting changes in object properties or behavior under varying conditions.

### Example Language Models

In at least some implementations, language models, such as large language models (LLMs), vision language models (VLMs), multi-modal language models (MMLMs), and/or other types of generative artificial intelligence (AI) can be implemented. Generally, the language models can be used to process, analyze, and generate multi-modal content (e.g., text, images, video, 3D models) in various applications, such as those within the 3D RCS pipeline described above. That is, the models can interpret and produce outputs that align with the specific requirements of the reconstruction, segmentation, densification, and/or simulation stages. These models can be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based at least in part on the context provided in input prompts or queries. These language models can be considered “large,” in implementations, based at least in part on the models being trained on massive datasets and having architectures with large number of learnable network parameters (weights and biases)—such as millions or billions of parameters. The LLMs/VLMs/MMLMs/etc. can be implemented for summarizing textual data, analyzing and extracting insights from data (e.g., textual, image, video, etc.), and generating new text/image/video/etc. in user-specified styles, tones, and/or formats. The LLMs/VLMs/MMLMs/etc. of the present disclosure can be used exclusively for text processing, in implementations, whereas in other implementations, multi-modal LLMs can be implemented to accept, understand, and/or generate text and/or other types of content like images, audio, 2D and/or 3D data (e.g., in USD formats), and/or video. For example, vision language models (VLMs), or more generally multi-modal language models (MMLMs), can be implemented to accept image, video, audio, textual, 3D design (e.g., CAD), and/or other inputs data types and/or to generate or output image, video, audio, textual, 3D design, and/or other output data types.

Various types of LLMs/VLMs/MMLMs/etc. architectures can be implemented in various implementations. For example, different architectures can be implemented that use different techniques for understanding and generating outputs-such as text, audio, video, image, 2D and/or 3D design or asset data, etc. In some implementations, LLMs/VLMs/MMLMs/etc. architectures such as recurrent neural networks (RNNs) or long short-term memory networks (LSTMs) can be used, while in other implementations transformer architectures—such as those that rely on self-attention and/or cross-attention (e.g., between contextual data and textual data) mechanisms—can be used to understand and recognize relationships between words or tokens and/or contextual data (e.g., other text, video, image, design data, USD, etc.). One or more generative processing pipelines that include LLMs/VLMs/MMLMs/etc. can also include one or more diffusion block(s) (e.g., denoisers). The LLMs/VLMs/MMLMs/etc. of the present disclosure can include encoder and/or decoder block(s). For example, discriminative or encoder-only models like BERT (Bidirectional Encoder Representations from Transformers) can be implemented for tasks that involve language comprehension such as classification, sentiment analysis, question answering, and named entity recognition. As another example, generative or decoder-only models like GPT (Generative Pretrained Transformer) can be implemented for tasks that involve language and content generation such as text completion, story generation, and dialogue generation. LLMs/VLMs/MMLMs/etc. that include both encoder and decoder components like T5 (Text-to-Text Transformer) can be implemented to understand and generate content, such as for translation and summarization. These examples are not intended to be limiting, and any architecture type—including but not limited to those described herein—can be implemented depending on the particular implementation and the task(s) being performed using the LLMs/VLMs/MMLMs/etc.

In various implementations, the LLMs/VLMs/MMLMs/etc. can be trained using unsupervised learning, in which an LLMs/VLMs/MMLMs/etc. learns patterns from large amounts of unlabeled text/audio/video/image/design/USD/etc. data. Due to the extensive training, in implementations, the models cannot require task-specific or domain-specific training. LLMs/VLMs/MMLMs/etc. that have undergone extensive pre-training on vast amounts of unlabeled data can be referred to as foundation models and can be adept at a variety of tasks like question-answering, summarization, filling in missing information, translation, image/video/design/USD/data generation. Some LLMs/VLMs/MMLMs/etc. can be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some implementations, the LLMs/VLMs/MMLMs/etc. of the present disclosure can be implemented using various model alignment techniques. For example, in some implementations, guardrails can be implemented to identify improper or undesired inputs (e.g., prompts) and/or outputs of the models. In doing so, the system can use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some implementations, one or more additional models—or layers thereof—can be implemented to identify issues with inputs and/or outputs of the models. For example, these “safeguard” models can be trained to identify inputs and/or outputs that are “safe” or otherwise okay or desired and/or that are “unsafe” or are otherwise undesired for the particular application/implementation. As a result, the LLMs/VLMs/MMLMs/etc. of the present disclosure can be less likely to output language/text/audio/video/design data/USD data/etc. that can be offensive, vulgar, improper, unsafe, out of domain, and/or otherwise undesired for the particular application/implementation.

In some implementations, the LLMs/VLMs/etc. can be configured to or capable of accessing or using one or more plug-ins, application programming interfaces (APIs), databases, data stores, repositories, etc. For example, for certain tasks or operations that the model is not ideally suited for, the model can have instructions (e.g., as a result of training, and/or based at least in part on instructions in a given prompt) to access one or more plug-ins (e.g., 3^{rd} party plugins) for help in processing the current input. In such an example, where at least part of a prompt is related to restaurants or weather, the model can access one or more restaurant or weather plug-ins (e.g., via one or more APIs) to retrieve the relevant information. As another example, where at least part of a response requires a mathematical computation, the model can access one or more math plug-ins or APIs for help in solving the problem(s), and can then use the response from the plug-in and/or API in the output from the model. This process can be repeated—e.g., recursively—for any number of iterations and using any number of plug-ins and/or APIs until a response to the input prompt can be generated that addresses each ask/question/request/process/operation/etc. As such, the model(s) can not only rely on its own knowledge from training on a large dataset(s), but also on the expertise or optimized nature of one or more external resources—such as APIs, plug-ins, and/or the like.

In some implementations, multiple language models (e.g., LLMs/VLMs/MMLMs/etc., multiple instances of the same language model, and/or multiple prompts provided to the same language model or instance of the same language model can be implemented, executed, or accessed (e.g., using one or more plug-ins, user interfaces, APIs, databases, data stores, repositories, etc.) to provide output responsive to the same query, or responsive to separate portions of a query. In at least one implementation, multiple language models e.g., language models with different architectures, language models trained on different (e.g. updated) corpuses of data can be provided with the same input query and prompt (e.g., set of constraints, conditioners, etc.). In one or more implementations, the language models can be different versions of the same foundation model. In one or more implementations, at least one language model can be instantiated as multiple agents—e.g., more than one prompt can be provided to constrain, direct, or otherwise influence a style, a content, or a character, etc., of the output provided. In one or more example, non-limiting implementations, the same language model can be asked to provide output corresponding to a different role, perspective, character, or having a different base of knowledge, etc.—as defined by a supplied prompt.

In any one of such implementations, the output of two or more (e.g., each) language models, two or more versions of at least one language model, two or more instanced agents of at least one language model, and/or two more prompts provided to at least one language model can be further processed, e.g., aggregated, compared or filtered against, or used to determine (and provide) a consensus response. In one or more implementations, the output from one language model—or version, instance, or agent—can be provided as input to another language model for further processing and/or validation. In one or more implementations, a language model can be asked to generate or otherwise obtain an output with respect to an input source material, with the output being associated with the input source material. Such an association can include, for example, the generation of a caption or portion of text that is embedded (e.g., as metadata) with an input source text or image. In one or more implementations, an output of a language model can be used to determine the validity of an input source material for further processing, or inclusion in a dataset. For example, a language model can be used to assess the presence (or absence) of a target word in a portion of text or an object in an image, with the text or image being annotated to note such presence (or lack thereof). Alternatively, the determination from the language model can be used to determine whether the source material should be included in a curated dataset, for example and without limitation.

FIG. 9A is a block diagram of an example generative language model system 900 suitable for use in implementing at least some implementations of the present disclosure. Generally, the example generative language model system 900 can be used with different stages of the 3D RCS pipeline. That is, the system can generate parameters, refine segmentation outputs, and simulate object behaviors during reconstruction, segmentation, densification, and/or simulation stages. In the example illustrated in FIG. 9A, the generative language model system 900 includes a retrieval augmented generation (RAG) component 992, an input processor 905, a tokenizer 910, an embedding component 920, plug-ins/APIs 995, and a generative language model (LM) 930 (which can include an LLM, a VLM, a multi-modal LM, etc.).

At a high level, the input processor 905 can receive an input 901 including text and/or other types of input data (e.g., audio data, video data, image data, sensor data (e.g., LiDAR, RADAR, ultrasonic, etc.), 3D design data, CAD data, universal scene descriptor (USD) data-such as OpenUSD, etc.), depending on the architecture of the generative LM 930 (e.g., LLM/VLM/MMLM/etc.). In some implementations, the input 901 includes plain text in the form of one or more sentences, paragraphs, and/or documents. Additionally or alternatively, the input 901 can include numerical sequences, precomputed embeddings (e.g., word or sentence embeddings), and/or structured data (e.g., in tabular formats, JSON, or XML). In some implementations in which the generative LM 930 is capable of processing multi-modal inputs, the input 901 can combine text (or can omit text) with image data, audio data, video data, design data, USD data, and/or other types of input data, such as but not limited to those described herein. Taking raw input text as an example, the input processor 905 can prepare raw input text in various ways. For example, the input processor 905 can perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 905 can remove stopwords to reduce noise and focus the generative LM 930 on more meaningful content. The input processor 905 can apply text normalization, for example, by converting all characters to lowercase, removing accents, and/or or handling special cases like contractions or abbreviations to ensure consistency. These are just a few examples, and other types of input processing can be applied.

In some implementations, a RAG component 992 (which can include one or more RAG models, and/or can be performed using the generative LM 930 itself) can be used to retrieve additional information to be used as part of the input 901 or prompt. RAG can be used to enhance the input to the LLM/VLM/MMLM/etc. with external knowledge, so that answers to specific questions or queries or requests are more relevant—such as in a case where specific knowledge is required. The RAG component 992 can fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some implementations, the input 901 can be generated using the query or input to the model (e.g., a question, a request, etc.) in addition to data retrieved using the RAG component 992. In some implementations, the input processor 905 can analyze the input 901 and communicate with the RAG component 992 (or the RAG component 992 can be part of the input processor 905, in implementations) in order to identify relevant text and/or other data to provide to the generative LM 930 as additional context or sources of information from which to identify the response, answer, or output 990, generally. For example, where the input indicates that the user is interested in a desired tire pressure for a particular make and model of vehicle, the RAG component 992 can retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 992 can retrieve a prior stored conversation history—or at least a summary thereof—and include the prior conversation history along with the current ask/request as part of the input 901 to the generative LM 930.

The RAG component 992 can use various RAG techniques. For example, naïve RAG can be used where documents are indexed, chunked, and applied to an embedding model to generate embeddings corresponding to the chunks. A user query can also be applied to the embedding model and/or another embedding model of the RAG component 992 and the embeddings of the chunks along with the embeddings of the query can be compared to identify the most similar/related embeddings to the query, which can be supplied to the generative LM 930 to generate an output.

In some implementations, more advanced RAG techniques can be used. For example, prior to passing chunks to the embedding model, the chunks can undergo pre-retrieval processes (e.g., routing, rewriting, metadata analysis, expansion, etc.). In addition, prior to generating the final embeddings, post-retrieval processes (e.g., re-ranking, prompt compression, etc.) can be performed on the outputs of the embedding model prior to final embeddings being used as comparison to an input query.

As a further example, modular RAG techniques can be used, such as those that are similar to naïve and/or advanced RAG, but also include features such as hybrid search, recursive retrieval and query engines, StepBack approaches, sub-queries, and hypothetical document embedding.

As another example, Graph RAG can use knowledge graphs as a source of context or factual information. Graph RAG can be implemented using a graph database as a source of contextual information sent to the LLM/VLM/MMLM/etc. Rather than (or in addition to) providing the model with chunks of data extracted from larger sized documents—which can result in a lack of context, factual correctness, language accuracy, etc.—graph RAG can also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such implementations, can contain relevant textual content and metadata about the knowledge graph as well as be integrated with a vector database. In some implementations, the graph RAG can use a graph as a subject matter expert, where descriptions of concepts and entities relevant to a query/prompt can be extracted and passed to the model as semantic context. These descriptions can include relationships between the concepts. In other examples, the graph can be used as a database, where part of a query/prompt can be mapped to a graph query, the graph query can be executed, and the LLM/VLM/MMLM/etc. can summarize the results. In such an example, the graph can store relevant factual information, and a query (natural language query) to graph query tool (NL-to-Graph-query tool) and entity linking can be used. In some implementations, graph RAG (e.g., using a graph database) can be combined with standard (e.g., vector database) RAG, and/or other RAG types, to benefit from multiple approaches.

In any implementations, the RAG component 992 can implement a plugin, API, user interface, and/or other functionality to perform RAG. For example, a graph RAG plug-in can be used by the LLM/VLM/MMLM/etc. to run queries against the knowledge graph to extract relevant information for feeding to the model, and a standard or vector RAG plug-in can be used to run queries against a vector database. For example, the graph database can interact with a plug-in's REST interface such that the graph database is decoupled from the vector database and/or the embeddings models.

The tokenizer 910 can segment the (e.g., processed) text data into smaller units (tokens) for subsequent analysis and processing. The tokens can represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 930 to understand morphological variations and handle out-of-vocabulary words more effectively. Character-based tokenization represents each character as a separate token, enabling the generative LM 930 to process text at a fine-grained level. The choice of tokenization strategy can depend on factors such as the language being processed, the task at hand, and/or characteristics of the training dataset. As such, the tokenizer 910 can convert the (e.g., processed) text into a structured format according to tokenization schema being implemented in the particular implementation.

The embedding component 920 can use any known embedding technique to transform discrete tokens into (e.g., dense, continuous vector) representations of semantic meaning. For example, the embedding component 920 can use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 901 includes image data/video data/etc., the input processor 901 can resize the data to a standard size compatible with format of a corresponding input channel and/or can normalize pixel values to a common range (e.g., 0 to 1) to ensure a consistent representation, and the embedding component 920 can encode the image data using any known technique (e.g., using one or more convolutional neural networks (CNNs) to extract visual features). In some implementations in which the input 901 includes audio data, the input processor 901 can resample an audio file to a consistent sampling rate for uniform processing, and the embedding component 920 can use any known technique to extract and encode audio features-such as in the form of a spectrogram (e.g., a mel-spectrogram). In some implementations in which the input 901 includes video data, the input processor 901 can extract frames or apply resizing to extracted frames, and the embedding component 920 can extract features such as optical flow embeddings or video embeddings and/or can encode temporal information or sequences of frames. In some implementations in which the input 901 includes multi-modal data, the embedding component 920 can fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 930 and/or other components of the generative LM system 900 can use different types of neural network architectures depending on the implementation. For example, transformer-based architectures such as those used in models like GPT can be implemented, and can include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 920 can apply an encoded representation of the input 901 to the generative LM 930, and the generative LM 930 can process the encoded representation of the input 901 to generate an output 990, which can include responsive text and/or other types of data.

As described herein, in some implementations, the generative LM 930 can be configured to access or use—or capable of accessing or using-plug-ins/APIs 995 (which can include one or more plug-ins, application programming interfaces (APIs), databases, data stores, repositories, etc.). For example, for certain tasks or operations that the generative LM 930 is not ideally suited for, the model can have instructions (e.g., as a result of training, and/or based at least in part on instructions in a given prompt, such as those retrieved using the RAG component 992) to access one or more plug-ins/APIs 995 (e.g., 3^{rd} party plugins) for help in processing the current input. In such an example, where at least part of a prompt is related to restaurants or weather, the model can access one or more restaurant or weather plug-ins (e.g., via one or more APIs), send at least a portion of the prompt related to the particular plug-in/API 995 to the plug-in/API 995, the plug-in/API 995 can process the information and return an answer to the generative LM 930, and the generative LM 930 can use the response to generate the output 990. This process can be repeated—e.g., recursively—for any number of iterations and using any number of plug-ins/APIs 995 until an output 990 that addresses each ask/question/request/process/operation/etc. from the input 901 can be generated. As such, the model(s) can not only rely on its own knowledge from training on a large dataset(s) and/or from data retrieved using the RAG component 992, but also on the expertise or optimized nature of one or more external resources—such as the plug-ins/APIs 995.

FIG. 9B is a block diagram of an example implementation in which the generative LM 930 includes a transformer encoder-decoder. Generally, the generative LM 930 can generate model parameters and processing rules for stages of the 3D RCS pipeline. That is, the generative LM 930 can generate segmentation masks, update camera poses, and adjust simulation parameters based at least in part on input data. For example, assume input text such as “Who discovered gravity” is tokenized (e.g., by the tokenizer 910 of FIG. 9A) into tokens such as words, and each token is encoded (e.g., by the embedding component 920 of FIG. 9A) into a corresponding embedding (e.g., of size 512). Since these token embeddings typically do not represent the position of the token in the input sequence, any known technique can be used to add a positional encoding to each token embedding to encode the sequential relationships and context of the tokens in the input sequence. As such, the (e.g., resulting) embeddings can be applied to one or more encoder(s) 935 of the generative LM 930.

In an example implementation, the encoder(s) 935 forms an encoder stack, where each encoder includes a self-attention layer and a feedforward network. In an example transformer architecture, each token (e.g., word) flows through a separate path. As such, each encoder can accept a sequence of vectors, passing each vector through the self-attention layer, then the feedforward network, and then upwards to the next encoder in the stack. Any known self-attention technique can be used. For example, to calculate a self-attention score for each token (word), a query vector, a key vector, and a value vector can be created for each token, a self-attention score can be calculated for pairs of tokens by taking the dot product of the query vector with the corresponding key vectors, normalizing the resulting scores, multiplying by corresponding value vectors, and summing weighted value vectors. The encoder can apply multi-headed attention in which the attention mechanism is applied multiple times in parallel with different learned weight matrices. Any number of encoders can be cascaded to generate a context vector encoding the input. An attention projection layer 940 can convert the context vector into attention vectors (keys and values) for the decoder(s) 945.

In an example implementation, the decoder(s) 945 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 935, in an example transformer architecture, each token (e.g., word) flows through a separate path in the decoder(s) 945. During a first pass, the decoder(s) 945, a classifier 950, and a generation mechanism 955 can generate a first token, and the generation mechanism 955 can apply the generated token as an input during a second pass. The process can repeat in a loop, successively generating and adding tokens (e.g., words) to the output from the preceding pass and applying the token embeddings of the composite sequence with positional encodings as an input to the decoder(s) 945 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 935, except that it creates its queries from the layer below it and takes the keys and values (e.g., matrix) from the output of the encoder(s) 935.

As such, the decoder(s) 945 can output some decoded (e.g., vector) representation of the input being applied during a particular pass. The classifier 950 can include a multi-class classifier including one or more neural network layers that project the decoded (e.g., vector) representation into a corresponding dimensionality (e.g., one dimension for each supported word or token in the output vocabulary) and a softmax operation that converts log its to probabilities. As such, the generation mechanism 955 can select or sample a word or token based at least in part on a corresponding predicted probability (e.g., select the word with the highest predicted probability) and append it to the output from a previous pass, generating each word or token sequentially. The generation mechanism 955 can repeat the process, triggering successive decoder inputs and corresponding predictions until selecting or sampling a symbol or token that represents the end of the response, at which point, the generation mechanism 955 can output the generated response.

FIG. 9C is a block diagram of an example implementation in which the generative LM 930 includes a decoder-only transformer architecture. For example, the decoder(s) 960 of FIG. 9C can operate similarly as the decoder(s) 945 of FIG. 9B except each of the decoder(s) 960 of FIG. 9C omits the encoder-decoder self-attention layer (since there is no encoder in this implementation). As such, the decoder(s) 960 can form a decoder stack, where each decoder includes a self-attention layer and a feedforward network. Furthermore, instead of encoding the input sequence, a symbol or token representing the end of the input sequence (or the beginning of the output sequence) can be appended to the input sequence, and the resulting sequence (e.g., corresponding embeddings with positional encodings) can be applied to the decoder(s) 960. As with the decoder(s) 945 of FIG. 9B, each token (e.g., word) can flow through a separate path in the decoder(s) 960, and the decoder(s) 960, a classifier 965, and a generation mechanism 970 can use auto-regression to sequentially generate one token at a time until predicting a symbol or token that represents the end of the response. The classifier 965 and the generation mechanism 970 can operate similarly as the classifier 950 and the generation mechanism 955 of FIG. 9B, with the generation mechanism 970 selecting or sampling each successive output token based at least in part on a corresponding predicted probability and appending it to the output from a previous pass, generating each token sequentially until selecting or sampling a symbol or token that represents the end of the response. These and other architectures described herein are meant simply as examples, and other suitable architectures can be implemented within the scope of the present disclosure.

### Example Computing Device

FIG. 10 is a block diagram of an example computing device(s) 1000 suitable for use in implementing some implementations of the present disclosure. Generally, the example computing device(s) 1000 can execute various stages of the 3D RCS pipeline, such as reconstruction, segmentation, preprocessing, densification, and/or simulation. That is, the computing device(s) 1000 can perform computations to generate 3D representations, segment objects, process volumetric data, densify objects, and/or simulate object interactions within the pipeline. Computing device 1000 can include an interconnect system 1002 that directly or indirectly couples the following devices: memory 1004, one or more central processing units (CPUs) 1006, one or more graphics processing units (GPUs) 1008, a communication interface 1010, input/output (I/O) ports 1012, input/output components 1014, a power supply 1016, one or more presentation components 1018 (e.g., display(s)), and one or more logic units 1020. In at least one implementation, the computing device(s) 1000 can include one or more virtual machines (VMs), and/or any of the components thereof can include virtual components (e.g., virtual hardware components). For non-limiting examples, one or more of the GPUs 1008 can include one or more vGPUs, one or more of the CPUs 1006 can include one or more vCPUs, and/or one or more of the logic units 1020 can include one or more virtual logic units. As such, a computing device(s) 1000 can include discrete components (e.g., a full GPU dedicated to the computing device 1000), virtual components (e.g., a portion of a GPU dedicated to the computing device 1000), or a combination thereof.

Although the various blocks of FIG. 10 are shown as connected via the interconnect system 1002 with lines, this is not intended to be limiting and is for clarity only. For example, in some implementations, a presentation component 1018, such as a display device, can be considered an I/O component 1014 (e.g., if the display is a touch screen). As another example, the CPUs 1006 and/or GPUs 1008 can include memory (e.g., the memory 1004 can be representative of a storage device in addition to the memory of the GPUs 1008, the CPUs 1006, and/or other components). As such, the computing device of FIG. 10 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 10.

The interconnect system 1002 can represent one or more links or busses, such as an address bus, a data bus, a control bus, or a combination thereof. The interconnect system 1002 can include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some implementations, there are direct connections between components. As an example, the CPU 1006 can be directly connected to the memory 1004. Further, the CPU 1006 can be directly connected to the GPU 1008. Where there is direct, or point-to-point connection between components, the interconnect system 1002 can include a PCIe link to carry out the connection. In these examples, a PCI bus need not be included in the computing device 1000.

The memory 1004 can include any of a variety of computer-readable media. The computer-readable media can be any available media that can be accessed by the computing device 1000. The computer-readable media can include both volatile and nonvolatile media, and removable and non-removable media. By way of example, and not limitation, the computer-readable media can include computer-storage media and communication media.

The computer-storage media can include both volatile and nonvolatile media and/or removable and non-removable media implemented in any method or technology for storage of information such as computer-readable instructions, data structures, program modules, and/or other data types. For example, the memory 1004 can store computer-readable instructions (e.g., that represent a program(s) and/or a program element(s), such as an operating system. Computer-storage media can include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 1000. As used herein, computer storage media does not include signals per se.

The computer storage media can embody computer-readable instructions, data structures, program modules, and/or other data types in a modulated data signal such as a carrier wave or other transport mechanism and includes any information delivery media. The term “modulated data signal” can refer to a signal that has one or more of its characteristics set or changed in such a manner as to encode information in the signal. By way of example, and not limitation, the computer storage media can include wired media such as a wired network or direct-wired connection, and wireless media such as acoustic, RF, infrared and other wireless media. Combinations of any of the above should also be included within the scope of computer-readable media.

The CPU(s) 1006 can be configured to execute at least some of the computer-readable instructions to control one or more components of the computing device 1000 to perform one or more of the methods and/or processes described herein. The CPU(s) 1006 can each include one or more cores (e.g., one, two, four, eight, twenty-eight, seventy-two, etc.) that are capable of handling a multitude of software threads simultaneously. The CPU(s) 1006 can include any type of processor, and can include different types of processors depending on the type of computing device 1000 implemented (e.g., processors with fewer cores for mobile devices and processors with more cores for servers). For example, depending on the type of computing device 1000, the processor can be an Advanced RISC Machines (ARM) processor implemented using Reduced Instruction Set Computing (RISC) or an x86 processor implemented using Complex Instruction Set Computing (CISC). The computing device 1000 can include one or more CPUs 1006 in addition to one or more microprocessors or supplementary co-processors, such as math co-processors.

In addition to or alternatively from the CPU(s) 1006, the GPU(s) 1008 can be configured to execute at least some of the computer-readable instructions to control one or more components of the computing device 1000 to perform one or more of the methods and/or processes described herein. One or more of the GPU(s) 1008 can be an integrated GPU (e.g., with one or more of the CPU(s) 1006 and/or one or more of the GPU(s) 1008 can be a discrete GPU. In implementations, one or more of the GPU(s) 1008 can be a coprocessor of one or more of the CPU(s) 1006. The GPU(s) 1008 can be used by the computing device 1000 to render graphics (e.g., 3D graphics) or perform general purpose computations. For example, the GPU(s) 1008 can be used for General-Purpose computing on GPUs (GPGPU). The GPU(s) 1008 can include hundreds or thousands of cores that are capable of handling hundreds or thousands of software threads simultaneously. The GPU(s) 1008 can generate pixel data for output images in response to rendering commands (e.g., rendering commands from the CPU(s) 1006 received via a host interface). The GPU(s) 1008 can include graphics memory, such as display memory, for storing pixel data or any other suitable data, such as GPGPU data. The display memory can be included as part of the memory 1004. The GPU(s) 1008 can include two or more GPUs operating in parallel (e.g., via a link). The link can directly connect the GPUs (e.g., using NVLINK) or can connect the GPUs through a switch (e.g., using NVSwitch). When combined together, each GPU 1008 can generate pixel data or GPGPU data for different portions of an output or for different outputs (e.g., a first GPU for a first image and a second GPU for a second image). Each GPU can include its own memory, or can share memory with other GPUs.

In addition to or alternatively from the CPU(s) 1006 and/or the GPU(s) 1008, the logic unit(s) 1020 can be configured to execute at least some of the computer-readable instructions to control one or more components of the computing device 1000 to perform one or more of the methods and/or processes described herein. In implementations, the CPU(s) 1006, the GPU(s) 1008, and/or the logic unit(s) 1020 can discretely or jointly perform any combination of the methods, processes and/or portions thereof. One or more of the logic units 1020 can be part of and/or integrated in one or more of the CPU(s) 1006 and/or the GPU(s) 1008 and/or one or more of the logic units 1020 can be discrete components or otherwise external to the CPU(s) 1006 and/or the GPU(s) 1008. In implementations, one or more of the logic units 1020 can be a coprocessor of one or more of the CPU(s) 1006 and/or one or more of the GPU(s) 1008.

Examples of the logic unit(s) 1020 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which can include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1010 can include one or more receivers, transmitters, and/or transceivers that allow the computing device 1000 to communicate with other computing devices via an electronic communication network, included wired and/or wireless communications. The communication interface 1010 can include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more implementations, logic unit(s) 1020 and/or communication interface 1010 can include one or more data processing units (DPUs) to transmit data received over a network and/or through interconnect system 1002 directly to (e.g., a memory of) one or more GPU(s) 1008.

The I/O ports 1012 can allow the computing device 1000 to be logically coupled to other devices including the I/O components 1014, the presentation component(s) 1018, and/or other components, some of which can be built in to (e.g., integrated in) the computing device 1000. Illustrative I/O components 1014 include a microphone, mouse, keyboard, joystick, game pad, game controller, satellite dish, scanner, printer, wireless device, etc. The I/O components 1014 can provide a natural user interface (NUI) that processes air gestures, voice, or other physiological inputs generated by a user. In some examples, inputs can be transmitted to an appropriate network element for further processing. An NUI can implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1000. The computing device 1000 can be include depth cameras, such as stereoscopic camera systems, infrared camera systems, RGB camera systems, touchscreen technology, and combinations of these, for gesture detection and recognition. Additionally, the computing device 1000 can include accelerometers or gyroscopes (e.g., as part of an inertia measurement unit (IMU)) that allow detection of motion. In some examples, the output of the accelerometers or gyroscopes can be used by the computing device 1000 to render immersive augmented reality or virtual reality.

The power supply 1016 can include a hard-wired power supply, a battery power supply, or a combination thereof. The power supply 1016 can provide power to the computing device 1000 to allow the components of the computing device 1000 to operate.

The presentation component(s) 1018 can include a display (e.g., a monitor, a touch screen, a television screen, a heads-up-display (HUD), other display types, or a combination thereof), speakers, and/or other presentation components. The presentation component(s) 1018 can receive data from other components (e.g., the GPU(s) 1008, the CPU(s) 1006, DPUs, etc.), and output the data (e.g., as an image, video, sound, etc.).

### Example Data Center

FIG. 11 illustrates an example data center 1100 that can be used in at least one implementations of the present disclosure. Generally, the example data center 1100 can support the execution of computations and storage for the 3D RCS pipeline. That is, the data center 1100 can process and store data for stages such as reconstruction, segmentation, densification, and/or simulation. The data center 1100 can include a data center infrastructure layer 1110, a framework layer 1120, a software layer 1130, and/or an application layer 1140.

As shown in FIG. 11, the data center infrastructure layer 1110 can include a resource orchestrator 1112, grouped computing resources 1114, and node computing resources (“node C.R.s”) 1116(1)-1116(N), where “N” represents any whole, positive integer. In at least one implementation, node C.R.s 1116(1)-1116(N) can include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some implementations, one or more node C.R.s from among node C.R.s 1116(1)-1116(N) can correspond to a server having one or more of the above-mentioned computing resources. In addition, in some implementations, the node C.R.s 1116(1)-11161(N) can include one or more virtual components, such as vGPUs, vCPUs, and/or the like, and/or one or more of the node C.R.s 1116(1)-1116(N) can correspond to a virtual machine (VM).

In at least one implementation, grouped computing resources 1114 can include separate groupings of node C.R.s 1116 housed within one or more racks (not shown), or many racks housed in data centers at various geographical locations (also not shown). Separate groupings of node C.R.s 1116 within grouped computing resources 1114 can include grouped compute, network, memory or storage resources that can be configured or allocated to support one or more workloads. In at least one implementation, several node C.R.s 1116 including CPUs, GPUs, DPUs, and/or other processors can be grouped within one or more racks to provide compute resources to support one or more workloads. The one or more racks can also include any number of power modules, cooling modules, and/or network switches, in any combination.

The resource orchestrator 1112 can configure or otherwise control one or more node C.R.s 1116(1)-1116(N) and/or grouped computing resources 1114. In at least one implementation, resource orchestrator 1112 can include a software design infrastructure (SDI) management entity for the data center 1100. The resource orchestrator 1112 can include hardware, software, or some combination thereof.

In at least one implementation, as shown in FIG. 11, framework layer 1120 can include a job scheduler 1128, a configuration manager 1134, a resource manager 1136, and/or a distributed file system 1138. The framework layer 1120 can include a framework to support software 1132 of software layer 1130 and/or one or more application(s) 1142 of application layer 1140. The software 1132 or application(s) 1142 can respectively include web-based service software or applications, such as those provided by Amazon Web Services, Google Cloud and Microsoft Azure. The framework layer 1120 can be, but is not limited to, a type of free and open-source software web application framework such as Apache Spark™ (hereinafter “Spark”) that can use distributed file system 1138 for large-scale data processing (e.g., “big data”). In at least one implementation, job scheduler 1128 can include a Spark driver to facilitate scheduling of workloads supported by various layers of data center 1100. The configuration manager 1134 can be capable of configuring different layers such as software layer 1130 and framework layer 1120 including Spark and distributed file system 1138 for supporting large-scale data processing. The resource manager 1136 can be capable of managing clustered or grouped computing resources mapped to or allocated for support of distributed file system 1138 and job scheduler 1128. In at least one implementation, clustered or grouped computing resources can include grouped computing resource 1114 at data center infrastructure layer 1110. The resource manager 1136 can coordinate with resource orchestrator 1112 to manage these mapped or allocated computing resources.

In at least one implementation, software 1132 included in software layer 1130 can include software used by at least portions of node C.R.s 1116(1)-1116(N), grouped computing resources 1114, and/or distributed file system 1138 of framework layer 1120. One or more types of software can include, but are not limited to, Internet web page search software, e-mail virus scan software, database software, and streaming video content software.

In at least one implementation, application(s) 1142 included in application layer 1140 can include one or more types of applications used by at least portions of node C.R.s 1116(1)-1116(N), grouped computing resources 1114, and/or distributed file system 1138 of framework layer 1120. One or more types of applications can include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more implementations.

In at least one implementation, any of configuration manager 1134, resource manager 1136, and resource orchestrator 1112 can implement any number and type of self-modifying actions based at least in part on any amount and type of data acquired in any technically feasible fashion. Self-modifying actions can relieve a data center operator of data center 1100 from making possibly bad configuration decisions and possibly avoiding underutilized and/or poor performing portions of a data center.

The data center 1100 can include tools, services, software or other resources to train one or more machine learning models or predict or infer information using one or more machine learning models according to one or more implementations described herein. For example, a machine learning model(s) can be trained by calculating weight parameters according to a neural network architecture using software and/or computing resources described above with respect to the data center 1100. In at least one implementation, trained or deployed machine learning models corresponding to one or more neural networks can be used to infer or predict information using resources described above with respect to the data center 1100 by using weight parameters calculated through one or more training techniques, such as but not limited to those described herein.

In at least one implementation, the data center 1100 can use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above can be configured as a service to allow users to train or performing inferencing of information, such as image recognition, speech recognition, or other artificial intelligence services.

### Example Network Environments

Network environments suitable for use in implementing implementations of the disclosure can include one or more client devices, servers, network attached storage (NAS), other backend devices, and/or other device types. The client devices, servers, and/or other device types (e.g., each device) can be implemented on one or more instances of the computing device(s) 1000 of FIG. 10—e.g., each device can include similar components, features, and/or functionality of the computing device(s) 1000. In addition, where backend devices (e.g., servers, NAS, etc.) are implemented, the backend devices can be included as part of a data center 1100, an example of which is described in more detail herein with respect to FIG. 11.

Components of a network environment can communicate with each other via a network(s), which can be wired, wireless, or both. The network can include multiple networks, or a network of networks. By way of example, the network can include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) can provide wireless connectivity.

Compatible network environments can include one or more peer-to-peer network environments—in which case a server cannot be included in a network environment—and one or more client-server network environments—in which case one or more servers can be included in a network environment. In peer-to-peer network environments, functionality described herein with respect to a server(s) can be implemented on any number of client devices.

In at least one implementation, a network environment can include one or more cloud-based network environments, a distributed computing environment, a combination thereof, etc. A cloud-based network environment can include a framework layer, a job scheduler, a resource manager, and a distributed file system implemented on one or more of servers, which can include one or more core network servers and/or edge servers. A framework layer can include a framework to support software of a software layer and/or one or more application(s) of an application layer. The software or application(s) can respectively include web-based service software or applications. In implementations, one or more of the client devices can use the web-based service software or applications (e.g., by accessing the service software and/or applications via one or more application programming interfaces (APIs)). The framework layer can be, but is not limited to, a type of free and open-source software web application framework such as that can use a distributed file system for large-scale data processing (e.g., “big data”).

A cloud-based network environment can provide cloud computing and/or cloud storage that carries out any combination of computing and/or data storage functions described herein (or one or more portions thereof). Any of these various functions can be distributed over multiple locations from central or core servers (e.g., of one or more data centers that can be distributed across a state, a region, a country, the globe, etc.). If a connection to a user (e.g., a client device) is relatively close to an edge server(s), a core server(s) can designate at least a portion of the functionality to the edge server(s). A cloud-based network environment can be private (e.g., limited to a single organization), can be public (e.g., available to many organizations), and/or a combination thereof (e.g., a hybrid cloud environment).

The client device(s) can include at least some of the components, features, and functionality of the example computing device(s) 1000 described herein with respect to FIG. 10. By way of example and not limitation, a client device can be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure can be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure can be practiced in a variety of system configurations, including hand-held devices, consumer electronics, general-purpose computers, more specialty computing devices, etc. The disclosure can also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” can include only element A, only element B, only element C, element A and element B, element A and element C, element B and element C, or elements A, B, and C. In addition, “at least one of element A or element B” can include at least one of element A, at least one of element B, or at least one of element A and at least one of element B. Further, “at least one of element A and element B” can include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described.

What is claimed is:

1. A system, comprising:
one or more processors to execute one or more operations to:
obtain video data comprising a depth map of a scene;
reconstruct a three-dimensional (3D) representation of the scene using at least one or more Gaussian splat representations of one or more objects in the scene and the depth map;
segment at least one object in the 3D representation by:
generating a two-dimensional (2D) segmentation mask of a reference view of the video data;
interpolating the 2D segmentation mask over a plurality of frames of the video data; and
mapping the 2D segmentation mask over the plurality of frames onto at least one corresponding region of a plurality of regions of the 3D representation to segment the at least one object in the 3D representation from the scene;
update at least one of the plurality of regions of the 3D representation within a threshold distance of the at least one object in the scene; and
generate at least one image of the 3D representation that depicts at least a portion of the at least one object for display.

2. The system of claim 1, wherein the one or more operations comprise at least one operation to:
densify the at least one object by:
sampling a plurality of points on or approximately around the at least one object in the scene;
generating a voxelized volume of the at least one object based at least in part on the plurality of points; and
updating the voxelized volume based at least in part on an occupancy state of at least one voxel of a plurality of voxels of the voxelized volume based at least in part on at least one rendered depth map.

3. The system of claim 2, wherein the one or more processors are to execute the one or more operations comprising:
populate an interior of the voxelized volume based at least in part on injecting a plurality of volumetric elements in the interior of the at least one object comprising a plurality of interior regions; and
simulate one or more interactions of the voxelized volume of the at least one densified object to update at least one physical attribute of the at least one object, the at least one densified object corresponding to a volumetric representation.

4. The system of claim 3, wherein to simulate the one or more interactions of the voxelized volume, the one or more processors are to perform a rigidity simulation comprising:
applying, using a first physics model, a first plurality of transformations to the at least one densified object to obtain a plurality of rigid motions of the at least one densified object based at least in part on:
determining an energy function using at least one of a plurality of scene parameters or a plurality of object parameters;
minimizing the energy function to determine a plurality of rigid states of the at least one densified object; and
applying the plurality of rigid states to simulate the plurality of rigid motions of the at least one densified object over time.

5. The system of claim 3, wherein to simulate the one or more interactions of the voxelized volume, the one or more processors are to perform an elasticity simulation comprising:
applying, using a second physics model, a second plurality of transformations to the at least one densified object to obtain a plurality of deformed states of the at least one densified object based at least in part on:
determining an energy function using at least one of a plurality of scene parameters or a plurality of object parameters;
minimizing the energy function to determine a plurality of updates to a plurality of control points; and
calculating one or more deformations of the at least one densified object based at least in part on the plurality of updates to the plurality of control points and a plurality of corresponding skinning fields.

6. The system of claim 1, wherein:
the one or more operations to reconstruct the 3D representation of the scene is further based on at least one of: (i) at least one refined pose of the video source, or (ii) a plurality of two-dimensional (2D) frames of the video data; and
the one or more operations to reconstruct the 3D representation of the scene further comprises at least one operation to update at least one initial pose of the video source to the at least one refined pose based at least in part on aligning the 3D representation with the plurality of frames of the video data.

7. The system of claim 6, wherein the one or more operations further comprise at least one operation to:
generate an initial Gaussian splat representation based at least in part on depth data of the depth map and the at least one initial pose corresponding to the video data; and
generate a 3D reconstruction based at least in part on the initial Gaussian splat representation, the at least one refined pose of the video data, and the plurality of frames of the video data.

8. The system of claim 1, wherein the one or more operations to segment at least one object in the 3D representation comprises at least one operation to use a segmentation model, and wherein the reference view is based at least in part on a user input selecting the at least one object, the reference view corresponding to a frame of the plurality of frames of the video data.

9. The system of claim 1, wherein the one or more operations to update the at least one of the plurality of regions of the 3D representation within the threshold distance comprises at least one operation to:
fill at least one of the plurality of regions within the distance based at least in part on sampling data of one or more adjacent regions; and
remove one or more elements of at least one of the plurality of regions within the distance and updating the at least one of the plurality of regions based at least in part on sampling data of one or more regions of the plurality of regions of the 3D representation.

10. The system of claim 1, wherein the one or more processors are comprised in at least one of:
a system for performing gaming;
a system for performing content streaming;
a system for performing collaborative content creation;
a system for performing simulation operations;
a system for performing collaborative content creation for 3D assets;
a system for generating synthetic data;
a system comprising one or more vision language models (VLMs);
a system comprising one or more large language models (LLMs);
a system for performing conversational AI operations;
a system for performing light transport simulation;
a system for performing deep learning operations;
a system for performing digital twin operations;
a control system for an autonomous or semi-autonomous machine;
a perception system for an autonomous or semi-autonomous machine;
a system incorporating one or more virtual machines (VMs);
a system implemented using a robot;
a system implemented using an edge device;
a system implemented at least partially in a data center;
a system implemented at least partially using cloud computing resources;
a system for generating interactive 3D visualizations; or
a system implemented at least partially using augmented reality (AR) or virtual reality (VR) platforms.

11. One or more processors, comprising:
one or more circuits to:
obtain video data comprising a depth map of a scene;
reconstruct, using at least one or more Gaussian splat representations and the depth map, the scene into a three-dimensional (3D) representation;
segment at least one object in the 3D representation based at least in part on mapping a two-dimensional (2D) segmentation mask of a reference view of the video data over a plurality of frames onto at least one corresponding region of a plurality of regions of the 3D representation;
update at least one of the plurality of regions of the 3D representation within a proximity of the at least one object in the scene; and
display at least one image of the 3D representation, the at least one image depicting at least a portion of the at least one object.

12. The one or more processors of claim 11, wherein the one or more circuits are to:
densify the at least one object by:
sampling a plurality of points on or approximately around the at least one object;
generating a voxelized volume of the at least one object based at least in part on the plurality of points; and
updating the voxelized volume based at least in part on an occupancy state of at least one voxel of a plurality of voxels of the voxelized volume based at least in part on at least one rendered depth map.

13. The one or more processors of claim 12, wherein the one or more circuits are to:
populate an interior of the voxelized volume based at least in part on injecting a plurality of volumetric elements in the interior of the at least one object comprising a plurality of interior regions; and
simulate one or more interactions of the voxelized volume of the at least one densified object to update at least one physical attribute of the at least one object, the at least one densified object corresponds to a volumetric representation.

14. The one or more processors of claim 13, wherein simulating the one or more interactions comprises performing a rigidity simulation comprising:
applying, using a first physics model, a first plurality of transformations to the at least one densified object to obtain a plurality of rigid motions of the at least one densified object based at least in part on:
determining an energy function using at least one of a plurality of scene parameters or a plurality of object parameters;
minimizing the energy function to determine a plurality of rigid states of the at least one densified object; and
applying the plurality of rigid states to simulate the plurality of rigid motions of the at least one densified object over time.

15. The one or more processors of claim 13, wherein simulating the one or more interactions comprises performing an elasticity simulation comprising:
applying, using a second physics model, a second plurality of transformations to the at least one densified object to obtain a plurality of deformed states of the at least one densified object based at least in part on:
determining an energy function using at least one of a plurality of scene parameters or a plurality of object parameters;
minimizing the energy function to determine a plurality of updates to a plurality of control points; and
calculating one or more deformations of the at least one densified object based at least in part on the plurality of updates to the plurality of control points and a plurality of corresponding skinning fields.

16. The one or more processors of claim 11, wherein:
the 3D representation of the scene is reconstructed based at least one of: (i) at least one refined pose of a video source, or (ii) a plurality of two-dimensional (2D) frames of the video data; and
the 3D representation of the scene is reconstructed by updating at least one initial pose of the video source to the at least one refined pose based at least in part on aligning the 3D representation with the plurality of 2D frames of the video data.

17. A method, comprising:
obtaining, by one or more processors, video data comprising a depth map of a scene;
reconstructing, by the one or more processors using at least one or more Gaussian splat representations and the depth map, the scene into a three-dimensional (3D) representation;
segmenting, by the one or more processors, at least one object in the 3D representation;
updating, by the one or more processors, at least one of a plurality of regions of the 3D representation within a distance of the at least one object in the scene;
densifying, by the one or more processors, the at least one object by:
generating a voxelized volume of the at least one object; and
updating the voxelized volume based at least in part on an occupancy state of at least one voxel of a plurality of voxels of the voxelized volume based at least in part on at least one rendered depth map;
simulating, by the one or more processors, one or more interactions of the voxelized volume of the at least one densified object; and
displaying, by the one or more processors, at least one image depicting at least a portion of the at least one densified object.

18. The method of claim 17, further comprising:
populating, by the one or more processors, an interior of the voxelized volume based at least in part on injecting a plurality of volumetric elements in the interior of the at least one object comprising a plurality of interior regions.

19. The method of claim 17, wherein simulating the one or more interactions comprises performing a rigidity simulation comprising:
applying, by the one or more processors using a first physics model, a first plurality of transformations to the at least one densified object to obtain a plurality of rigid motions of the at least one densified object based at least in part on:
determining an energy function using at least one of a plurality of scene parameters or a plurality of object parameters;
minimizing the energy function to determine a plurality of rigid states of the at least one densified object; and
applying the plurality of rigid states to simulate the plurality of rigid motions of the at least one densified object over time.

20. The method of claim 17, wherein simulating the one or more interactions comprises performing an elasticity simulation comprising:
applying, by the one or more processors using a second physics model, a second plurality of transformations to the at least one densified object to obtain a plurality of deformed states of the at least one densified object based at least in part on:
determining an energy function using at least one of a plurality of scene parameters or a plurality of object parameters;
minimizing the energy function to determine a plurality of updates to a plurality of control points; and
calculating one or more deformations of the at least one densified object based at least in part on the plurality of updates to the plurality of control points and a plurality of corresponding skinning fields.
